(19) United States
(12) Patent Application Publication
(10) Pub. No.: US 2025/0370306 A1
(43) Pub. Date: Dec. 4, 2025

(54) Chemically-Resistant Multi-Layered Electro-Optic Device and a Method of Making the Same

(71) Applicant: E Ink Corporation, Billerica, MA (US)

(72) Inventors: Song ZHANG, Mountain View, CA (US); Mary E. PARENT, Mountain View, CA (US); Hua GU, Dublin, CA (US); Haiyan GU, Fremont, CA (US); Yuriy Borisovich MATUS, Pleasanton, CA (US); Setareh NIKNEZHAD, San Jose, CA (US)

(21) Appl. No.: 19/219,291

(22) Filed: May 27, 2025

Related U.S. Application Data
(60) Provisional application No. 63/653,626, filed on May 30, 2024.

(51) Int. Cl. G02F 1/167; G02F 1/1681

(52) U.S. Cl. CPC G02F 1/167; G02F 1/1681

(57) ABSTRACT

The present invention is directed to a chemically-resistant electro-optic device and a method of manufacture of the same. The device comprises a first substrate layer, a first light-transmissive electrode layer, an electro-optic material layer, a second electrode layer comprising a conductive polymer, a first adhesive layer, and a second substrate layer comprising a thermoplastic resin. The first adhesive layer comprises polyurethane and poly(vinyl alcohol), the poly(vinyl alcohol) containing an acetoacetate functional group in its molecular structure.

### RELATED APPLICATION

This application claims priority to U.S. Provisional Patent Application No. 63/653,626 filed on May 30, 2024, which is incorporated by reference in its entirety, along with all other patents and patent applications disclosed herein.

### FIELD OF THE INVENTION

The present invention relates to a chemically-resistant multi-layered electro-optic device and a method of manufacture of the same. The chemically-resistant, water-resistant multi-layered electro-optic device comprises a first substrate layer, a first light-transmissive electrode layer, an electro-optic material layer, a second electrode layer, a first adhesive layer, and a second substrate layer. The first adhesive layer comprises a polyurethane or an acrylic polymer and a crosslinked poly(vinyl alcohol), the poly(vinyl alcohol) containing an acetoacetate functional group in its molecular structure.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic devices. This type of display is properly called “multi-stable” rather than bistable, although for convenience the term “bistable” may be used herein to cover both bistable and multi-stable displays.

One type of electro-optic device, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays.

Numerous patents and applications, which are assigned to or in the names of the Massachusetts Institute of Technology (MIT), E Ink Corporation, E Ink California, LLC, and related companies, describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder form a coherent layer positioned between two electrodes. In a microcell electrophoretic display, the charged particles and the fluid are not encapsulated within microcapsules but instead are retained within a plurality of cavities formed within a carrier medium, typically a polymeric film.

The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Patents Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540;_6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate layer comprising indium-tin-oxide (ITO) or a similar conductive coating (which acts as one electrode of the final display) on a plastic film, the capsules/binder coating being dried to form a coherent layer of the electrophoretic medium firmly adhered to the substrate layer. Separately, a backplane, containing an array of pixel electrodes and an appropriate arrangement of conductors to connect the pixel electrodes to drive circuitry, is prepared. To form the final display, the substrate layer having the capsule/binder layer thereon is laminated to the backplane using a lamination adhesive. In one preferred form of such a process, the backplane is flexible and is prepared by printing the pixel electrodes and conductors on a plastic film or other flexible substrate layer. The obvious lamination technique for mass production of displays by this process is roll lamination using a lamination adhesive.

An electrophoretic display normally comprises an electro-optic material layer and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electro-optic material layer comprises an electrode, the layer on the opposed side of the electro-optic material layer typically being a protective layer intended to prevent the movable electrode damaging the electro-optic material layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate layer comprising indium-tin-oxide (ITO) or a similar conductive coating on a plastic film. Separately, a backplane, containing an array of pixel electrodes and an appropriate arrangement of conductors to connect the pixel electrodes to drive circuitry, is prepared. To form the final display, the substrate layer having the electro-optic material layer is laminated to the backplane using a lamination adhesive.

The aforementioned U.S. Pat. No. 6,982,178 describes a method of assembling a solid electro-optic display, which is well adapted for mass production. Essentially, this patent describes a so-called “front plane laminate” (“FPL”) which comprises, in order, a light-transmissive electrode layer; an electro-optic material layer in electrical contact with light-transmissive electrode layer; an adhesive layer; and a release sheet. Typically, the light-transmissive electrode layer will be carried on a light-transmissive substrate layer, which is preferably flexible, in the sense that the substrate layer can be manually wrapped around a drum (say) 10 inches (254 mm) in diameter without permanent deformation. The substrate layer will typically be a polymeric film and will normally have a thickness in the range of about 1 to about 25 mil (25 to 634 μm), preferably about 2 to about 10 mil (51 to 254 μm). The light-transmissive electrode layer is conveniently a thin metal or metal oxide layer of, for example, aluminum or ITO, or maybe a conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate. Assembly of an electrophoretic display using such a front plane laminate may be effected by removing the release sheet from the front plane laminate and contacting the adhesive layer with the backplane under conditions effective to cause the adhesive layer to adhere to the backplane, thereby securing the adhesive layer, electro-optic material layer, and light-transmissive electrode layer to the backplane. This process is well adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises an electro-optic material layer sandwiched between two adhesive layers, one or both of the adhesive layers being covered by a release sheet. Another form of the double release sheet comprises a layer of a solid electro-optic material sandwiched between two release sheets. Both forms of the double release film are intended for use in a process generally similar to the process for assembling an electrophoretic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate may comprise, in order, at least one light-transmissive protective layer and a light-transmissive electrode layer; an adhesive layer; an electro-optic material layer; and a release sheet. This inverted front plane laminate is used to form an electro-optic device having a layer of lamination adhesive between the electro-optic material layer and the light-transmissive electrode layer; a second, typically thin layer of adhesive may or may not be present between the electro-optic material layer and a backplane. Such electro-optic displays can combine good resolution with good low temperature performance.

The contents of all of the above references are incorporated herein by reference in their entirety.

Electro-optic devices, including those comprising electrophoretic media, may be used in numerous applications, such as e-readers, e-notes, self-labels, outdoor signs, variable transmission windows, automobile surfaces, security markers, security labels, authentication films, and others. Some of the applications require resilience of the devices to various conditions, and resistance of the devices and their parts to various chemicals. These conditions may include exposure to moisture, exposure to other chemicals, such as organic solvents, or even submersion of the device to these solvents.

The use of a flexible and cost-effective manufacturing process for electro-optic devices is crucial. The optimum protocol would be to manufacture the encapsulated electrophoretic medium at a plant, but then to manufacture the electro-optic device at a different plant and at a later time. This is necessary because of the complex nature of the encapsulated electrophoretic medium and the use of the encapsulated electrophoretic medium for various applications by different entities. Intermediate electro-optic laminates, such as FPLs, inverse FPLs, and other intermediate electro-optic laminates, enable this objective. For example, an FPL may be manufactured at a plant, stored in a warehouse, and shipped to another plant to be converted to the device, after the attachment of additional layers. Typically, the conversion process includes the removal of one or more release sheets from the intermediate electro-optic laminate, exposing an adhesive layer, and connecting an additional layer onto the exposed adhesive surface. However, the presence of a release sheet may lead to challenges because it may limit the process of the conversion to specific equipment. In addition, the presence of a tacky adhesive layer in the absence of the release sheet may limit the ability of the manufacturer to form a web of the intermediate electro-optic laminate, increasing the storage and transportation costs.

Designing chemically-resistant electro-optic devices and, at the same time, developing a cost effective and convenient process of manufacturing is challenging, because the different objectives require different formulation and manufacturing strategies. The inventors of the present invention unexpectedly found that the use of an intermediate electro-optic laminate comprising a non-tacky adhesive layer, the intermediate electro-optic laminate having no release sheets, can provide a chemically-resistant electro-optic device that can be manufactured by a cost-effective and flexible process. The process of manufacturing includes a hot stamping step, during which a thermoplastic film is attached onto the adhesive layer of the intermediate electro-optic laminate. The hot stamping step comprises the step of pressuring together the thermoplastic film and the adhesive layer to form a substrate layer on an adhesive layer.

### SUMMARY OF THE INVENTION

In one aspect, the present invention is directed to a chemically-resistant multi-layered electro-optic device comprising, in order, a first substrate layer, a first light-transmissive electrode layer, an electro-optic material layer, a second electrode layer, a first adhesive layer, and a second substrate layer. The first adhesive layer comprises from 20 to 80 weight percent of a polyurethane, a crosslinked acrylic polymer, or a mixture of a polyurethane and a crosslinked acrylic polymer by weight of the first adhesive layer excluding solvents, and from 20 to 80 weight percent of a poly(vinyl alcohol) by weight of the first adhesive layer excluding solvents. The poly(vinyl alcohol) contains acetoacetyl functional groups in its molecular structure. The second substrate layer is formed using a thermoplastic film having a surface, the thermoplastic film comprising a thermoplastic resin. The thermoplastic film has a surface treatment such that the surface of the thermoplastic film comprises polar functional groups. At least a portion of the polar functional group are covalently bonded to the poly(vinyl alcohol) of the first adhesive layer, the covalent bonds being formed from a reaction between the acetoacetyl functional groups of the poly(vinyl alcohol) and the polar functional groups of the surface of the thermoplastic film. The thermoplastic film that is used to form the second substrate layer may comprise a thermoplastic resin selected from a group consisting of polyethylene, polypropylene, polybutylene, polyethylene terephthalate, an ethylene copolymer, a propylene copolymer, a butylene copolymer, and mixtures thereof. The poly(vinyl alcohol) may have a degree of hydrolysis of from 90 to 99 percent. The poly(vinyl alcohol) may be crosslinked, the crosslinked poly(vinyl alcohol) being formed by a reaction between the poly(vinyl alcohol) and a crosslinking agent. The crosslinking agent may be selected from the group consisting of dialdehyde, diamine, and organic zirconate. The crosslinking agent may be glyoxal, ZrO(OH)Cl*nH₂O, (NH₄)₂ZrO(CO₃)₂, or mixtures thereof. The poly(vinyl alcohol) may have number average molecular weight from 1,000 to 1,000,000 Daltons.

The first adhesive layer may further comprise a UV absorber. The UV absorber may be water soluble or water dispersible. The first adhesive layer may further comprise a light stabilizer. The light stabilizer may be water soluble or water dispersible. The light stabilizer may be a hindered amine light stabilizer (HALS). The first adhesive layer may have thickness of from 1 to 10 micrometers. The chemically-resistant electro-optic device may further comprise a second adhesive layer disposed between the first substrate layer and the first light-transmissive electrode layer or between the first light-transmissive electrode layer and the electro-optic material layer. The chemically-resistant electro-optic device may comprise a second adhesive layer that is disposed between the first substrate layer and the first light-transmissive electrode layer and a third adhesive layer that is disposed between the first light-transmissive electrode layer and the electro-optic material layer.

The electro-optic material layer of the chemically-resistant multi-layered electro-optic device comprises an electrophoretic medium, the electrophoretic medium comprising electrically charged pigment particles, a charge control agent, and a non-polar liquid. The electrophoretic medium may be encapsulated in a plurality of microcells or in a plurality of microcapsules. The electrophoretic medium may comprise two or more types of electrically charged particles having different color and/or electrical charge magnitude. In the case of a microcell device, which is an electrophoretic medium encapsulated in a plurality of microcells, each microcell of the plurality of microcells comprises a microcell bottom, microcell walls, a microcell opening, and a sealing layer, the sealing layer spans the microcell opening, the sealing layer being in contact with the second electrode layer.

The second electrode layer of the chemically-resistant electro-optic device may comprise a conductive polymer. The conductive polymer of the second electrode layer may be selected from the group consisting of poly(3,4-ethylenedioxythiophene) polystyrene sulfonate (PEDOT-PSS), polyacetylene, polyphenylene sulfide, polyphenylene vinylene and combinations thereof.

In the case that the first adhesive layer comprises a polyurethane or a mixture of a polyurethane and a crosslinked acrylic polymer, the polyurethane may have a glass transition temperature lower than 0° C., lower than −10° C., lower than −20° C., or lower than −30° C. The polyurethane may be crosslinked. The polyurethane of the first adhesive layer may be crosslinked. The polyurethane may have number average molecular weight of from 1,000 to 2,000,000 Daltons.

In the case that the first adhesive layer comprises a crosslinking acrylic polymer or a mixture of a polyurethane and a crosslinked acrylic polymer, the crosslinked acrylic polymer may be formed by a self-crosslinking acrylic polymer. The crosslinking acrylic polymer may be an acrylic polymer that comprises an epoxy functional group. The crosslinking acrylic polymer may be a self-crosslinking epoxy-acrylic emulsion, which is an acrylic polymer that is formed by emulsion polymerization. The weight ratio of the self-crosslinking acrylic polymer to poly(vinyl alcohol) may be from 0.15 to 0.30.

The chemically-resistant multi-layered electro-optic device of the present invention may comprise a piezoelectric layer comprising piezoelectric material. The piezoelectric layer may be disposed between the first light-transmissive electrode layer and the electro-optic material layer or between the second electrode layer and the electro-optic material layer.

In another aspect, the present invention is directed to a method for manufacture of a chemically-resistant multi-layered electro-optic device. The chemically-resistant multi-layered electro-optic device comprises in order a first substrate layer, a first light-transmissive electrode layer, an electro-optic material layer, a second electrode layer, a first adhesive layer, and a second substrate layer. The method for manufacture of a chemically-resistant multi-layered electro-optic device comprises the steps: (a) providing an electro-optic sheet, the electro-optic sheet comprising, in order, the first substrate layer, the first light transmissive electrode layer, the electro-optic material layer, and the second electrode layer comprising a conductive polymer; (b) forming a wet film on the second electrode layer by application of an aqueous adhesive composition onto the second electrode layer of the electro-optic sheet, the aqueous adhesive composition comprising (i) from 20 to 80 weight percent of a poly(vinyl alcohol) by weight of the aqueous adhesive composition excluding solvents, the poly(vinyl alcohol) containing acetoacetyl functional groups in its molecular structure, (ii) from 20 to 80 weight percent of a polyurethane, a self-crosslinking acrylic polymer, or a mixture of polyurethane and a self-crosslinking acrylic polymer by weight of the aqueous adhesive compositions excluding solvents, (iii) and an aqueous carrier; (c) curing the wet film by application of heat to form an intermediate electro-optic laminate, the intermediate electro-optic laminate comprising, in order, the first substrate layer, the first light-transmissive electrode layer, the electro-optic material layer, the second electrode layer, and an adhesive film, the adhesive film comprising from 20 to 80 weight percent of the polyurethane, the crosslinked acrylic polymer, or the mixture of the polyurethane or the crosslinked acrylic polymer by weight of the adhesive film excluding solvents, and from 20 to 80 weight percent of a poly(vinyl alcohol) by weight of the adhesive film excluding solvents, the poly(vinyl alcohol) comprising acetoacetyl functional groups, the adhesive film of the intermediate electro-optic laminate being non tacky at room temperature; (d) providing a thermoplastic film having a surface, the thermoplastic film comprising a thermoplastic resin selected from a group consisting of polyethylene, polypropylene, polybutylene, polyethylene terephthalate, an ethylene copolymer, a propylene copolymer, a butylene copolymer, and mixtures thereof, the thermoplastic film having a surface treatment, such that the surface of the thermoplastic film comprises polar functional groups; (e) pressuring together the thermoplastic film and the intermediate electro-optic laminate at a temperature of from 60° C. to 100° C., forming the chemically-resistant multi-layered electro-optic device, the first adhesive layer of the chemically-resistant multi-layered electro-optic device being disposed between the second substrate layer and the second electrode layer, the second substrate layer comprising the thermoplastic film, wherein at least a portion of the polar groups of the surface of the thermoplastic film react with acetoacetyl functional groups of the poly(vinyl alcohol) of the adhesive film such that the surface of the thermoplastic film of the second substrate layer is covalently bonded to the poly(vinyl alcohol) of the first adhesive layer.

The aqueous adhesive composition may also comprise from 0.5 to 8 weight percent of a crosslinking agent by weight of the aqueous adhesive composition excluding solvents; the adhesive film of the intermediate electro-optic laminate, which is formed in the curing step, comprises from 20 to 80 weight percent of a crosslinked poly(vinyl alcohol) by weight of the adhesive film excluding solvents, the crosslinked poly(vinyl alcohol) of the adhesive film comprising crosslinked acetoacetyl functional groups and non-crosslinked acetoacetyl functional groups.

If the aqueous adhesive composition comprises a self-crosslinking acrylic polymer or a mixture of polyurethane and a self-crosslinking acrylic polymer, the self-crosslinking acrylic polymer may comprise one or more epoxy functional groups.

The electro-optic material layer may comprise an electrophoretic medium; the electrophoretic medium may comprise electrically charged pigment particles, a charge control agent, and a non-polar liquid; the electrophoretic medium may be encapsulated in a plurality of microcells or in a plurality of microcapsules. If the electrophoretic medium is encapsulated in a plurality of microcells, each microcell of the plurality of microcells may comprise a microcell bottom, microcell walls, a microcell opening, and a sealing layer, the sealing layer spanning the microcell opening, the sealing layer being in contact with the second electrode layer.

The second electrode layer may comprise a conductive polymer. The conductive polymer may be selected from the group consisting of poly(3,4-ethylenedioxythiophene) polystyrene sulfonate (PEDOT-PSS), polyacetylene, polyphenylene sulfide, polyphenylene vinylene and combinations thereof.

The method may comprise a step of forming a web of the intermediate electro-optic laminate, after the formation of the intermediate electro-optic laminate. Then, pressuring together the thermoplastic film and the adhesive film of the intermediate electro-optic laminate at a temperature of from 60° C. to 100° C. may take place in a roll-to-roll process. For this step, roll-to-roll process means that the web of the intermediate electro-optic laminate and an web of the thermoplastic film are unrolled simultaneously upstream, move in parallel to each other towards a hot stamp stage, and pass through a hot stamp stage, where the thermoplastic film is pressured together with the adhesive film of the intermediate electro-optic laminate at an elevated temperature (from 60° C. to 100° C.). A continuous film comprising the thermoplastic film attached on the intermediate electro-optic laminate may be then rolled downstream of the hot stamp stage.

### BRIEF DESCRIPTION OF DRAWINGS

FIG. 1 illustrates a side view of a portion of a structure of a plurality of microcells before they are filled and sealed.

FIG. 2A illustrates a side view of an example of a portion of an electro-optic device of the present invention comprising microcells.

FIG. 2B illustrates a side view of an example of a portion of an electro-optic device of the present invention comprising microcapsules.

FIG. 3A illustrates a side view of an example of a portion of an electro-optic sheet that can be used to form an intermediate electro-optic laminate comprising microcells.

FIG. 3B illustrates a side view of an example of a portion of an electro-optic sheet that can be used to form an intermediate electro-optic laminate comprising microcapsules.

FIG. 4A illustrates a side view of an example of a portion of an intermediate electro-optic laminate that can be used to form an electro-optic device comprising microcells.

FIG. 4B illustrates a side view of an example of a portion of an intermediate electro-optic laminate that can be used to form an electro-optic device comprising microcapsules.

FIG. 5A is an illustration of a process for manufacturing an intermediate electro-optic laminate.

FIG. 5B shows a simplified illustration of a side view of the intermediate electro-optic laminate.

FIGS. 6A and 6B illustrate the hot stamping step for the manufacturing of an electro-optic device.

FIG. 7 shows a method for making microcells using a roll-to-roll process.

FIGS. 8A and 8B detail the production of microcells using photolithographic exposure through a photomask of a conductor film coated with a thermoset precursor.

FIGS. 8C and 8D detail an alternate embodiment in which a microcell array is fabricated using photolithography. In FIGS. 8C and 8D, a combination of top and bottom exposure is used, allowing the microcell walls in one lateral direction to be cured by top photomask exposure, and the walls in another lateral direction to be cured bottom exposure through the opaque base conductor film.

FIGS. 9A-9D illustrate the steps of filling and sealing an array of microcells.

FIG. 10A illustrates a side view of an example of intermediate electro-optic laminate of the present invention, the laminate comprising a piezoelectric material layer that is disposed between the electro-optic material layer and the second electrode layer.

FIG. 10B illustrates a side view of an example of a chemically-resistant electro-optic device of the present invention, the device being formed by the intermediate electro-optic laminate of FIG. 10A.

FIG. 11A illustrates a side view of an example of intermediate electro-optic laminate of the present invention, the laminate comprising a piezoelectric material layer that is disposed between the electro-optic material layer and the first light-transmissive electrode layer.

FIG. 11B illustrates a side view of an example of a chemically-resistant electro-optic device of the present invention, the device being formed by the intermediate electro-optic laminate of FIG. 11A.

FIGS. 12-15 illustrate side views of various examples of intermediate electro-optic laminates of the present invention, the intermediate electro-optic laminates comprising a piezoelectric material layer.

### DETAILED DESCRIPTION OF THE INVENTION

The term “excluding solvents”, referring to the weight of the first adhesive layer (or the aqueous adhesive composition) of the present invention, means that the referred weight of the adhesive layer does not include water and other solvents that may be present in the adhesive layer.

The term “molecular weight” or “MW” as used herein refers to the number average molecular weight, unless otherwise stated. The number average molecular weight may be measured by gel permeation chromatography.

As used herein, the term “excluding solvents” in relation to a weight of a composition, a film, or a layer of a device, is the weight of the composition, the film, or the layer minus the solvent or solvents that are present. The solvent may be water or an organic solvent, or a combination of water and an organic solvent.

As used herein, the term “aqueous carrier” in relation to a composition is water, or a combination of water and organic solvent that is present in the composition. The components of the aqueous carrier may be added in the composition during the preparation of the composition, which include carriers or impurities of the raw materials.

The “degree of hydrolysis” of a poly(vinyl alcohol) refers to percentage of aetate groups in the polymer that have been hydrolyzed to hydroxyl groups. Typically, a poly(vinyl alcohol) is manufactured by hydrolysis of the corresponding poly(vinyl acetate). The final polymer, unless fully hydrolyzed, contains both hydroxyl and unhydrolyzed acetate groups. Degree of hydrolysis (DH) is reported by the poly(vinyl alcohol) manufacturer as a percentage. The reported degree of hydrolysis value is derived by the equation: DH=[(Number of hydroxyl units in the polymer)×100]/(Number of hydroxyl units in the polymer+Number of acetate units in the polymer). The degree of hydrolysis can be determined by proton NMR. In the case of a poly(vinyl alcohol) of the present invention, which includes acetoacetyl functional groups, the number of acetoacetyl functional groups does not affect the degree of hydrolysis, as this number is not a variable in the above equation.

“Glass transition temperature” of a polymer, such as polyurethane, is the temperature at which a polymer transitions from a glassy state to a softer state. The glass transition state is measured by Differential Scanning Calorimetry.

The term “acrylic polymer” as used herein, refers to a type of polymer that is manufactured using esters of acrylic acid, esters of methacrylic acid, acrylic acid, and derivatives, methacrylic acid and derivatives, acrylic acid, and derivatives, and methacrylic acid and derivatives. The term “acrylic polymer” includes copolymers that are manufactured with a combination of monomers.

The term “web”, as used herein, is a long, continuous roll of flexible laminate or film.

The terms “crosslinking agent” and “crosslinker” are synonymous and refer to a reagent that can react with a crosslinkable polymer to form a crosslinked polymer.

The term “self-crosslinking acrylic polymer”, as used herein, is an acrylic polymer that can form bonds between its own chains (of the same or different molecules) to create a crosslinked polymer, typically without the need for a crosslinking agent.

The term “non tacky” in reference to an adhesive layer of an intermediate electro-optic laminate at room temperature, wherein the adhesive layer is on a surface of the intermediate electro-optic laminate, means that the adhesive layer does not stick to itself or other non tacky materials at room temperature. The term non tacky for an adhesive layer on the surface of the intermediate electro-optic laminate means that the intermediate electro-optic laminate can be stored at room temperature in a web. In the case of a corresponding tacky adhesive layer, it would be impractical to form a useful web of the corresponding laminate that can be used at a later time.

The term “room temperature” refers to temperatures between 20° C. and 30° C.

The term “pot life” of a composition is the amount of time that the composition remains in a workable liquid form at a specific temperature.

The term “chemically-resistant electro-optic device”, as used herein, refers to the integrity of an electro-optic display after exposure to organic solvents or water, or even after submersion of the device in such solvents for a specific time at a specific.

The term “light-transmissive” is used herein to mean that the layer thus designated transmits sufficient light to enable an observer, looking through that layer, to observe the change in display states of the electrophoretic medium, which will normally be viewed through the light-transmissive electrode layer and adjacent substrate layer, if present; in cases where the electrophoretic medium displays a change in reflectivity at non-visible wavelengths, the term “light-transmissive” should of course be interpreted to refer to transmission of the relevant non-visible wavelengths.

The term “contrast ratio” (CR) for an electro-optic display is defined as the ratio of the luminance of the brightest color (white) to that of the darkest color (black) that the display is capable of producing. Normally a high contrast ratio, or CR, is a desired aspect of a display.

Piezoelectricity is the charge that accumulates in a solid material in response to applied mechanical stress. Suitable piezoelectric materials may include polyvinylidene fluoride (PVDF), quartz (SiO₂), berlinite (AlPO₄), gallium orthophosphate (GaPO₄), tourmaline, barium titanate (BaTiO₃), lead zirconate titanate (PZT), zinc oxide (ZnO), aluminum nitride (AlN), lithium tantalite, lanthanum gallium silicate, potassium, sodium tartrate and any other known piezo materials. Piezoelectricity may be utilized to drive the pigments of an electrophoretic material of an electro-optic display to generate a charge for powering an electro-optic display. The electro-optic display can operate without a power source, powered solely by charges generated by the piezoelectric material. For example, in the case of electro-optic displays having electrophoretic material, voltage may be generated by bending or introducing stress to piezo material, and this voltage can be utilized to cause movement of the color pigments of the electrophoretic material of an electro-optic display. Electro-optic displays comprising electrophoretic media and piezoelectric materials have been previously disclosed, for example, in U.S. Pat. Nos. 7,002,728, and 7,679,814.

FIG. 1 illustrates a side view of a portion of a structure of a plurality of microcells 100 before they are filled and sealed. Each microcell comprises microcell bottom 101, microcell walls 102, and microcell opening 103.

### Structure of Electro-Optic Devices Comprising Microcells or Microcapsules

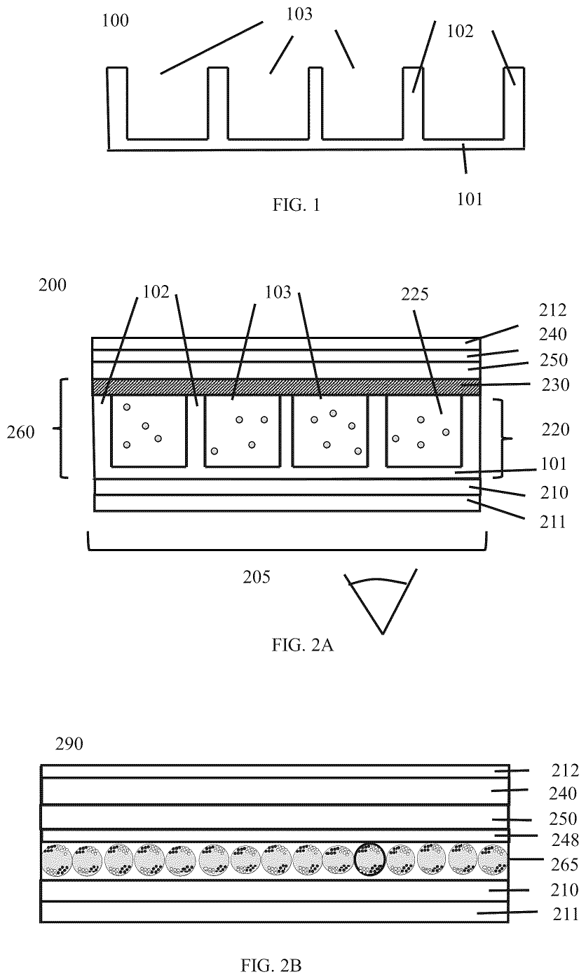

FIG. 2A illustrates a side view of an example of a portion of an electro-optic device 200 of the present invention comprising a plurality of microcells. This example of electro-optic device 200 comprises first substrate layer 211, first light-transmissive electrode layer 210, microcell layer 220, sealing layer 230, second electrode layer 250, first adhesive layer 240, and second substrate layer 212. Microcell layer 220 comprises a plurality of microcells that are defined by microcell bottom 101, microcell walls 102, and microcell openings 103. Each of the plurality of microcells contains electrophoretic medium 225, which comprises charged particles in a non-polar fluid. The electrophoretic medium 225 may also comprise a charge control agent. The microcells are sealed with sealing layer 230, the sealing layer spanning microcell openings 103 of the plurality of the microcells. Second electrode layer 250 is in contact with sealing layer 230. The electro-optic device may comprise a second adhesive layer (not shown in FIG. 2A), the second adhesive layer being disposed between sealing layer 230 and second electrode layer 250. Electro-optic material layer 260 of electro-optic device 200 comprises microcell layer 220 and sealing layer 230. A source of an electric field (not shown in FIG. 2A) may connect first light-transmissive electrode layer 210 with second electrode layer 250. Application of an electric field across electrophoretic material layer 260 causes the charge particles to migrate through the electrophoretic medium, creating an image that can be observed by an observer looking from viewing side 205 of electro-optic device 200. An optional primer layer (not shown in FIG. 2A) may be disposed between first light-transmissive electrode layer 210 and the plurality of microcells.

FIG. 2B illustrates a side view of an example of a portion of electro-optic device 290 of the present invention comprising a plurality of microcapsules. This example of electro-optic device 290 comprises first substrate layer 211, first light-transmissive electrode layer 210, electro-optic material layer 265, second adhesive layer 248, second electrode layer 250, first adhesive layer 240, and second substrate layer 212. Electro-optic material layer 265 comprises a plurality of microcapsules and a binder. The microcapsules include an electrophoretic medium, the electrophoretic medium comprising charged particles in a non-polar fluid. The electrophoretic medium may also comprise a charge control agent. A source of an electric field (not shown in FIG. 2B) may connect first light-transmissive electrode layer 210 with second electrode layer 250. Application of an electric field across electrophoretic material layer 265 causes the charge particles to migrate through the electrophoretic medium, creating an image that can be observed by an observer looking from viewing side of electro-optic device 200, the viewing side being the side of the device that is near first substrate layer 211.

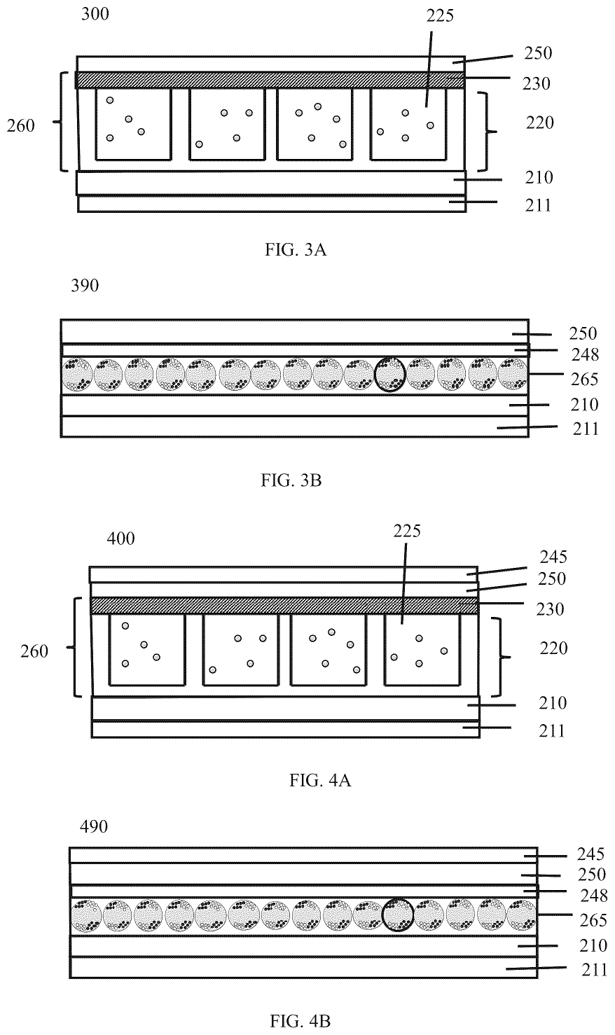

The example of an electro-optic device illustrated in FIG. 2A may be constructed by intermediate electro-optic laminate 400, which is shown in FIG. 4A. The intermediate electro-optic laminate 400 may be, in turn, constructed by electro-optic sheet 300, which is shown in FIG. 3A. Electro-optic sheet 300 comprises first substrate layer 211, first light-transmissive electrode layer 210, microcell layer 220, sealing layer 230, and second electrode layer 250. Electro-optic material layer 260 comprises microcell layer 220 and sealing layer 230. Intermediate electro-optic laminate 400 of FIG. 4A comprises first substrate layer 211, first light-transmissive electrode layer 210, microcell layer 220, sealing layer 230, second electrode layer 250, and adhesive film 245.

The example of an electro-optic device illustrated in FIG. 2B may be constructed by intermediate electro-optic laminate 490, which is shown in FIG. 4B. The intermediate electro-optic laminate 490 may be, in turn, constructed by electro-optic sheet 390, which is shown in FIG. 3B. Electro-optic sheet 390 comprises first substrate layer 211, first light-transmissive electrode layer 210, electro-optic material layer 265 comprising microcapsules and a binder, second adhesive layer 248, and second electrode layer 250. Intermediate electro-optic laminate 490 of FIG. 4B comprises first substrate layer 211, first light-transmissive electrode layer 210, electro-optic material layer 265 comprising microcapsules and a binder, second electrode layer 250, second adhesive layer 248, second electrode layer 250, and adhesive film 245.

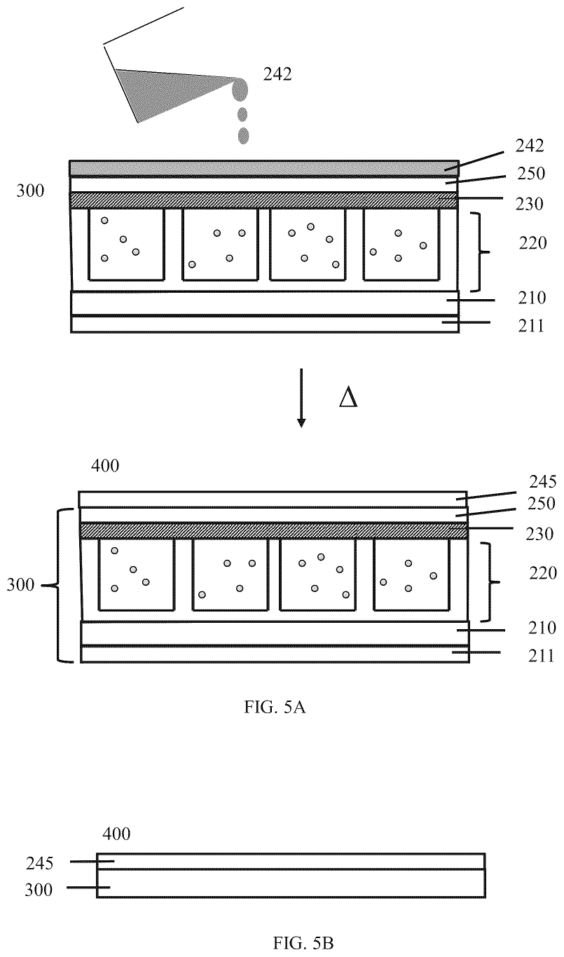

The electro-optic sheet 300 of FIG. 3A may be converted to the intermediate electro-optic laminate 400 of FIG. 4A, by applying an aqueous adhesive composition (252) onto second electrode layer 250 and curing the aqueous adhesive composition 252 thermally. Alternatively, the curing may take place via exposure of the adhesive layer to UV light. An example of a process of manufacture of the intermediate electro-optic laminate 400 from electro-optic sheet 300 is illustrated in FIG. 5A. Specifically, an aqueous adhesive composition 242 was applied onto second electrode layer 250 of electro-optic sheet 300, followed by heating the applied aqueous adhesive composition to form adhesive film 245. A simplified illustration of the intermediate electro-optic laminate 400 is shown in FIG. 5B.

The intermediate electro-optic laminate can be prepared, safely stored, and transported in a different location to be used for the manufacture of an electro-optic device. In fact, the adhesive layer of the intermediate electro-optic laminate is not tacky, and the intermediate electro-optic laminate can be rolled into a web, enabling its efficient storage.

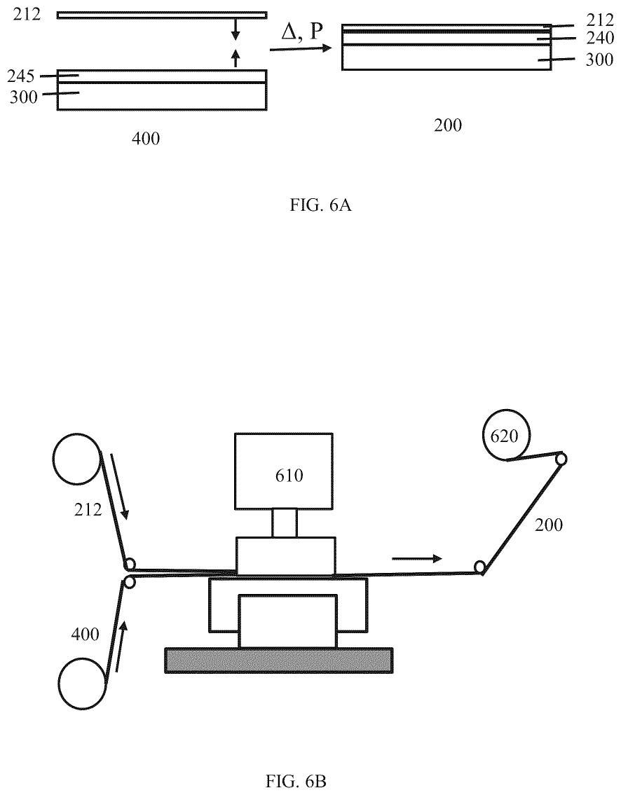

An example of the process of manufacture of electro-optic devices from an intermediate electro-optic laminate is illustrated in FIGS. 6A and 6B. In FIG. 6A, it is shown that a thermoplastic film 212 is connected to adhesive film 245 of intermediate electro-optic laminate 400 to provide an electro-optic device 200, wherein the thermoplastic film 212 serves as second substrate layer of electro-optic device 200. The attachment of thermoplastic film 212 onto the adhesive film (245) of intermediate electro-optic laminate 400 takes place by pressuring together the two components under elevated temperatures. FIG. 6B is an illustration of an example of this process step using hot stamping equipment. As shown in FIG. 6B, this step can take place via a roll-to-roll process. Thermoplastic film 212 and intermediate electro-optic laminate 400 from two different webs are fed in parallel to each other into a hot stamp stage (610), where a pressure is applied at elevated temperature. Pressure at elevated temperature enables the adhesion of adhesive film 245 of intermediate electro-optic laminate 400 onto the thermoplastic film (212), providing electro-optic device 200 comprising second substrate layer 212 bonded onto the first adhesive layer 240 of the device. The manufactured device 200 can be collected in a web (620). The web can be easily converted to the final device at a later time and at a different location by cutting portions of the web into the appropriate sizes. As mentioned above, the manufactured electro-optic device may comprise either microcells or microcapsules, depending on the structure of the intermediate electro-optic laminate (400 or 490).

### Formation of Microcell Arrays

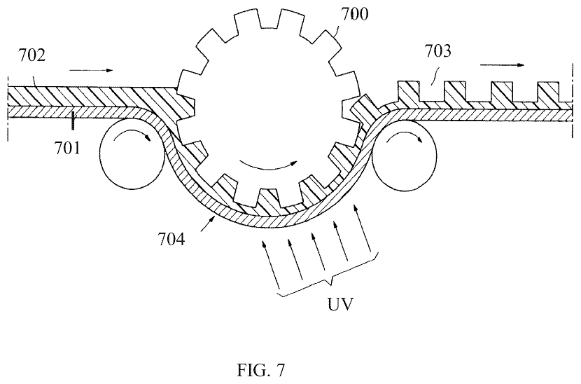

Techniques for constructing microcells. Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including benefit agent delivery and electrophoretic displays. Microcell arrays suitable for use with the invention can be created with microembossing, as illustrated in FIG. 7. A male mold (700) may be placed either above web 704 or below web 704 (not shown); however, alternative arrangements are possible. For examples, please see U.S. Pat. No. 7,715,088, which is incorporated herein by reference in its entirety. A conductive substrate layer may be constructed by forming conductor film 701 on polymer substrate layer that becomes the microcell bottom (or, as otherwise called, backing layer) for a device. The conductor film serves as the first light-transmissive electrode layer of the device. A composition comprising a thermoplastic, thermoset, or a precursor thereof 702 is then coated on the conductor film. The thermoplastic or thermoset precursor layer is embossed at a temperature higher than the glass transition temperature of the thermoplastics or thermoset precursor layer by the male mold in the form of a roller, plate, or belt.

The thermoplastic or thermoset precursor for the preparation of the microcells may be multifunctional acrylate or methacrylate, vinyl ether, epoxide and oligomers or polymers thereof, and the like. A combination of multifunctional epoxide and multifunctional acrylate is also very useful to achieve desirable physico-mechanical properties. A crosslinkable oligomer imparting flexibility, such as urethane acrylate or polyester acrylate, may be added to improve the flexure resistance of the embossed microcells. The composition may contain polymer, oligomer, monomer, and additives or only oligomer, monomer, and additives. The glass transition temperatures (or T_{g}) for this class of materials usually range from about −70° C. to about 150° C., or from about −20° C. to about 50° C. The microembossing process is typically carried out at a temperature higher than the T_{g}. A heated male mold or a heated housing substrate against which the mold presses may be used to control the microembossing temperature and pressure.

As shown in FIG. 7, the mold is released during or after the precursor layer is hardened to reveal an array of microcells 703. The hardening of the precursor layer may be accomplished by cooling, solvent evaporation, crosslinking by radiation, heat, or moisture. If the curing of the thermoset precursor is accomplished by UV radiation, UV may radiate onto the transparent conductor film from the bottom or the top of the web as shown in the two figures. Alternatively, UV lamps may be placed inside the mold. In this case, the mold must be transparent to allow the UV light to radiate through the pre-patterned male mold on to the thermoset precursor layer. A male mold may be prepared by any appropriate method, such as a diamond turn process or a photoresist process followed by either etching or electroplating. A master template for the male mold may be manufactured by any appropriate method, such as electroplating. With electroplating, a glass base is sputtered with a thin layer (typically 3000 Å) of a seed metal such as chrome inconel. The mold is then coated with a layer of photoresist and exposed to UV A photomask is placed between the UV and the layer of photoresist. The exposed areas of the photoresist become hardened. The unexposed areas are then removed by washing them with an appropriate solvent. The remaining hardened photoresist is dried and sputtered again with a thin layer of seed metal. The master is then ready for electroforming. A typical material used for electroforming is nickel cobalt. Alternatively, the master can be made of nickel by electroforming or electroless nickel deposition. The floor of the mold is typically between about 50 to 400 microns. The master can also be made using other microengineering techniques including e-beam writing, dry etching, chemical etching, laser writing or laser interference as described in “Replication techniques for micro-optics,” SPIE Proc. Vol. 3099, pp. 76-82 (1997). Alternatively, the mold can be made by photomachining using plastics, ceramics, or metals.

Prior to applying a UV curable resin composition, the mold may be treated with a mold release to aid in the demolding process. The UV curable resin may be degassed prior to dispensing and may optionally contain a solvent. The solvent, if present, readily evaporates. The UV curable resin is dispensed by any appropriate means such as, coating, dipping, pouring or the like, over the male mold. The dispenser may be moving or stationary. A conductor film is overlaid the UV curable resin. Pressure may be applied, if necessary, to ensure proper bonding between the resin and the plastic and to control the thickness of the microcell bottom. The pressure may be applied using a laminating roller, vacuum molding, press device or any other means. If the male mold is metallic and opaque, the plastic substrate is typically transparent to the actinic radiation used to cure the resin. Conversely, the male mold can be transparent, and the plastic substrate can be opaque to the actinic radiation. To obtain good transfer of the molded features onto the transfer sheet, the conductor film needs to have good adhesion to the UV curable resin, which should have a good release property against the mold surface.

Microcell arrays for the invention typically include a pre-formed conductor film, such as indium tin oxide (ITO) conductor lines; however, other conductive materials, such as silver or aluminum, may be used. The conductive layer may be backed by or integrated into substrate layers such as polyethylene terephthalate, polyethylene naphthalate, polyaramid, polyimide, polycycloolefin, polysulfone, epoxy and their composites. The conductor film may be coated with a radiation-curable polymer precursor layer. The film and precursor layer are then exposed imagewise to radiation to form the microcell wall structure. Following exposure, the precursor material is removed from the unexposed areas, leaving the cured microcell walls bonded to the conductor film/support web. The imagewise exposure may be accomplished by UV or other forms of radiation through a photomask to produce an image or predetermined pattern of exposure of the radiation curable material coated on the conductor film. Although it is generally not required, the photomask may be positioned and aligned with respect to the conductor film, i.e., ITO lines, so that the transparent photomask portions align with the spaces between ITO lines, and the opaque photomask portions align with the ITO material (intended for microcell floor areas).

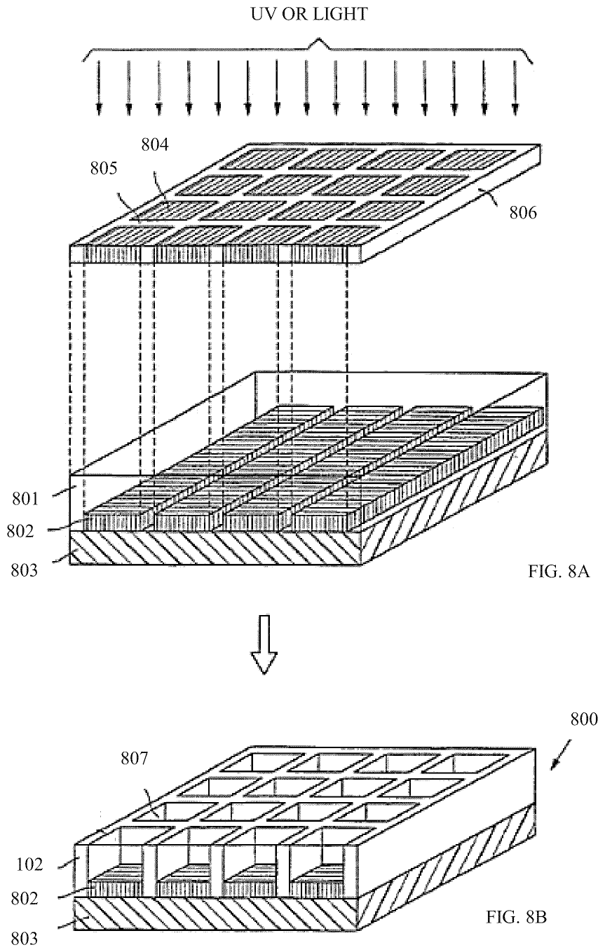

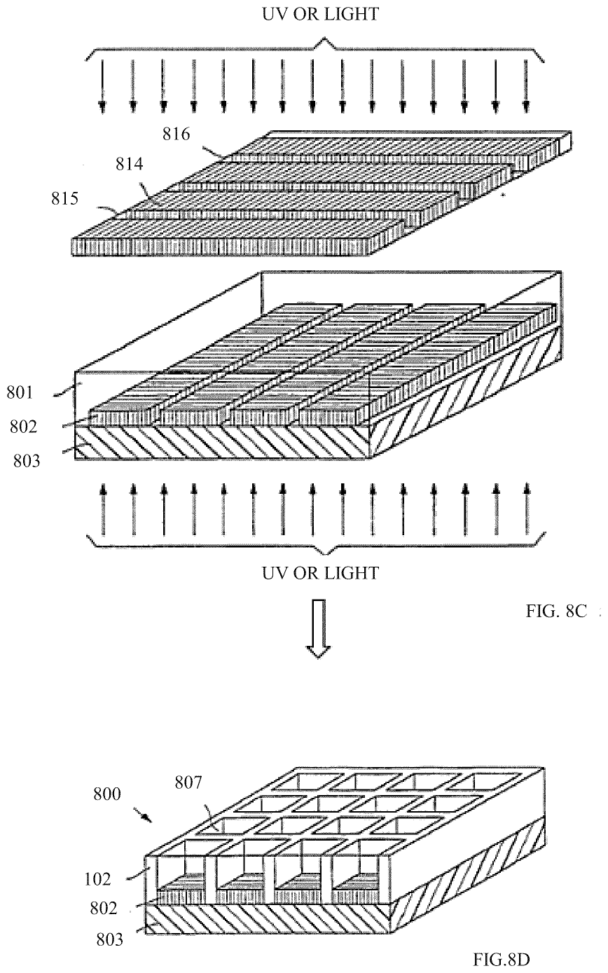

Photolithography. Microcells can also be produced using photolithography. Photolithographic processes for fabricating a microcell array are illustrated in FIGS. 8A and 8B. As shown in FIGS. 8A and 8B, the microcell array 800 may be prepared by exposure of radiation curable material 801 coated by known methods onto conductor film 802 to UV light (or, alternatively, to other forms of radiation, electron beams and the like) through photomask 806 to form microcell walls 102 corresponding to the image projected through photomask 806. Conductor film 802 is preferably mounted on a substrate layer (803), which may comprise a plastic material.

In photomask 806 of FIG. 8A, dark squares represent the opaque area 804 of the photomask and the space between the dark squares represents transparent area 805 of photomask 806. The UV radiates through transparent area 805 of photomask 806 onto radiation curable material 801. The exposure is preferably performed directly onto radiation curable material 801, i.e., the UV does not pass through substrate layer 803 or conductor film 802 (top exposure). For this reason, neither substrate layer 803 nor conductor film 802 needs to be transparent to the UV or to other radiation wavelengths employed.

As shown in FIG. 8B, exposed areas, such as microcell walls 102, become hardened. The unexposed areas (protected by opaque area 804 of photomask 806) are then removed by an appropriate solvent or developer to form microcells 807. The solvent or developer is selected from those commonly used for dissolving or reducing the viscosity of radiation curable materials, such as methylethylketone (MEK), toluene, acetone, isopropanol, or the like. The preparation of the microcells may be similarly accomplished by placing a photomask underneath the conductor film/substrate support web. In this case, the UV light radiates through the photomask from the bottom and the substrate needs to be transparent to radiation.

Imagewise Exposure. Still another alternative method for the preparation of the microcell array of the invention by imagewise exposure is illustrated in FIGS. 8C and 8D. When opaque conductor lines are used, the conductor lines can be used as the photomask for the exposure from the bottom. Durable microcell walls are formed by additional exposure from the top through a second photomask having opaque lines perpendicular to the conductor lines. FIG. 8C illustrates the use of both the top and bottom exposure principles to produce microcell array 800 of the invention. Conductor film 802 is opaque and line-patterned. Radiation curable material 801, which is coated on conductor film 802 and substrate layer 803, is exposed from the bottom through conductor film 802, which serves as the first photomask. A second exposure is performed from the “top” side through second photomask 816 having a line pattern perpendicular to conductor film 802. Spaces 815 between lines 814 are substantially transparent to the UV light. In this process, microcell wall material 801 is cured from the bottom up in one lateral orientation and cured from the top down in the perpendicular direction, joining to form microcell walls 102 of integral microcells 807. As shown in FIG. 8D, the unexposed area is then removed by a solvent or developer as described above to reveal microcells 807.

The microcells may be constructed from thermoplastic elastomers, which have good compatibility with the microcells and do not interact with the media. Examples of useful thermoplastic elastomers include ABA, and (AB)n type of di-block, tri-block, and multi-block copolymers wherein A is styrene, α-methylstyrene, ethylene, propylene or norbornene; B is butadiene, isoprene, ethylene, propylene, butylene, dimethylsiloxane or propylene sulfide; and A and B cannot be the same in the formula. The number, n, is ≥1, preferably 1-10. Particularly useful are di-block or tri-block copolymers of styrene or ox-methylstyrene such as SB (poly(styrene-b-butadiene)), SBS (poly(styrene-b-butadiene-b-styrene)), SIS (poly(styrene-bα-isoprene-b-styrene)), SEBS (poly(styrene-b-ethylene/butylenes-b-styrene)) poly(styrene-b-dimethylsiloxane-b-styrene) poly(α-methylstyrene-b-isoprene), poly(α-ene-b-isoprene-b-α-methylstyrene), poly(α-methylstyrene-b-propylene sulfide-b-α-methylstyrene), poly(α-methylstyrene-b-dimethylsiloxane-b-α-methylstyrene). Commercially available styrene block copolymers such as Kraton) and G series (from Kraton Polymer, Houston, Tex.) are particularly useful. Crystalline rubbers such as poly(ethylene-co-propylene-co-5-methylene-2-norbomene) or EPDM (ethylene-propylene-diene terpolymer) rubbers such as Vistalon 6505 (from Exxon Mobil, Houston, Tex.) and their grafted copolymers have also been found very useful.

The thermoplastic elastomers may be dissolved in a solvent or solvent mixture, which is immiscible with the carrier in the microcells and exhibits a specific gravity less than that of the carrier. Low surface tension solvents are preferred for the overcoating composition because of their better wetting properties over the microcell walls and the fluid. Solvents or solvent mixtures having a surface tension lower than 35 dyne/cm, or lower than 30 dyne/cm, are preferred. Suitable solvents include alkanes (preferably C₆₋₁₂ alkanes such as heptane, octane or Isopar solvents from Exxon Chemical Company, nonane, decane and their isomers), cycloalkanes (preferably C₆₋₁₂ cycloalkanes such as cyclohexane and decalin and the like), alkylbezenes (preferably mono- or di-C₁₋₆ alkyl benzenes such as toluene, xylene and the like), alkyl esters (preferably C₂₋₅ alkyl esters such as ethyl acetate, isobutyl acetate and the like) and C₃₋₅ alkyl alcohols (such as isopropanol and the like and their isomers). Mixtures of alkylbenzene and alkane are particularly useful.

In addition to polymer additives, the polymer mixtures may also include wetting agents (surfactants). Wetting agents (such as the FC surfactants from 3M Company, Zonyl fluorosurfactants from DuPont, fluoroacrylates, fluoromethacrylates, fluoro-substituted long chain alcohols, perfluoro-substituted long chain carboxylic acids and their derivatives, and Silwet silicone surfactants from OSi, Greenwich, Conn.) may also be included in the composition to improve the adhesion of the sealant to the microcells and provide a more flexible coating process. Other ingredients including crosslinking agents (e.g., bisazides such as 4,4′-diazidodiphenylmethane and 2,6-di-(4′-azidobenzal)-4-methylcyclohexanone), vulcanizers (e.g., 2-benzothiazolyl disulfide and tetramethylthiuram disulfide), multifunctional monomers or oligomers (e.g., hexanediol, diacrylates, trimethylolpropane, triacrylate, divinylbenzene, diallylphthalene), thermal initiators (e.g., dilauroryl peroxide, benzoyl peroxide) and photoinitiators (e.g., isopropyl thioxanthone (ITX), Irgacure 651 and Irgacure 369 from Ciba-Geigy) are also highly useful to enhance the physico-mechanical properties of the sealing layer by crosslinking or polymerization reactions during or after the overcoating process.

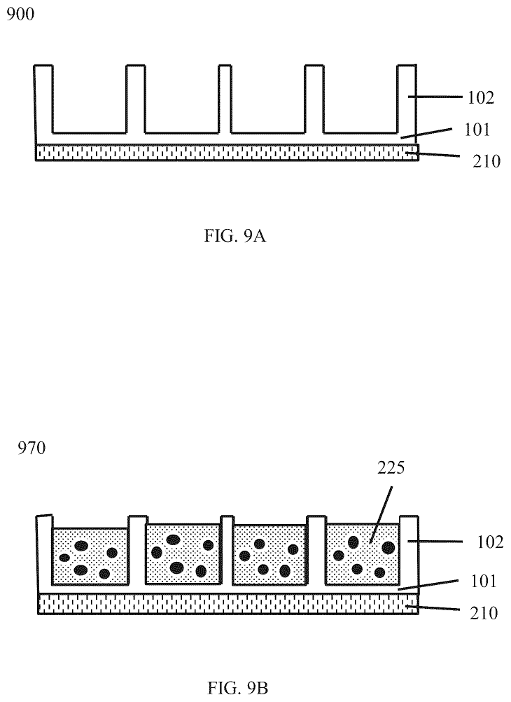

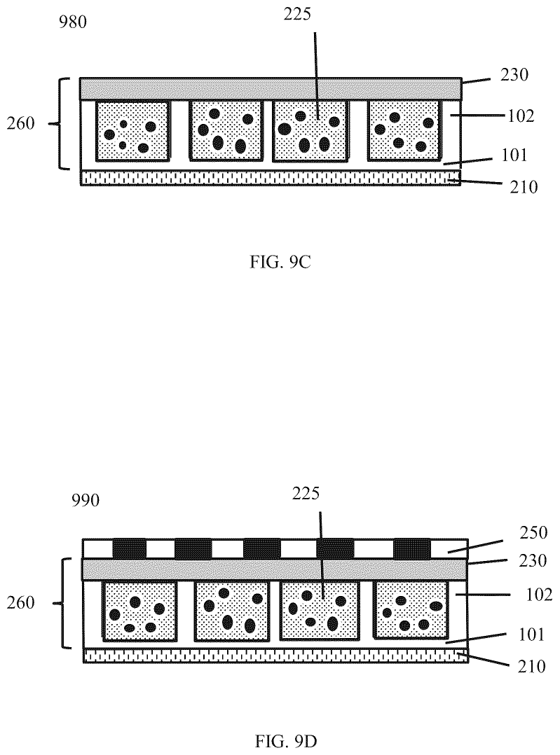

The microcell array 900 may be prepared by any of the methods described above. As shown in cross-section in FIGS. 9A-9), microcell walls 102 extend upward from microcell bottom 101 and first light-transmissive electrode layer 210, which can serve as the first light-transmissive electrode layer of the electro-optic device, to form the open microcells In an embodiment, first light-transmissive electrode layer 210 is formed on or at microcell bottom 101. While FIGS. 9A-9D show first light-transmissive electrode 210 is continuous and running above microcell bottom 101, it is also possible that first light-transmissive electrode layer 210 is continuous and running below or within microcell bottom 101 or it is interrupted by microcell walls 102. FIG. 2A illustrates microcell array comprising first light-transmissive electrode layer 210.

The microcells are next filled with electrophoretic medium 225, which comprises charged particles in a non-polar fluid to form a plurality of filled microcells. The microcells may be filled using a variety of techniques. In some embodiments, blade coating may be used to fill the microcells to the depth of microcell walls 102. In other embodiments, inkjet-type microinjection may be used to fill the microcells. In yet other embodiments, microneedle arrays may be used to fill an array of microcells with electrophoretic medium 225. FIG. 9B illustrates filled microcells 970.

As shown in FIG. 9C, after filling, the microcells are sealed by applying an aqueous sealing composition to form sealed microcells 980, comprising sealing layer 230. In some embodiments, the sealing process may involve exposure to beat, dry hot air, or UV radiation. The sealing layer must have good barrier properties for the non-polar fluid of electrophoretic medium 225. FIG. 9C illustrates filled and sealed microcells 980.

In alternate embodiments, a variety of individual microcells may be filled with the desired mixture by using iterative photolithography. The process typically includes coating an array of empty microcells with a layer of positively working photoresist, selectively opening a certain number of the microcells by image-wise exposing the positive photoresist, followed by developing the photoresist, filling the opened microcells with the desired mixture, and sealing the filled microcells by a sealing process. These steps may be repeated to create sealed microcells filled with other mixtures. This procedure allows for the formation of large sheets of microcells having the desired ratio of mixtures or concentrations.

The sealing of the filled microcells may be accomplished in a number of ways. One approach involves the mixing of the aqueous sealing composition with the electrophoretic medium composition. The aqueous sealing composition may be immiscible with the electrophoretic composition, preferably having a specific gravity lower than that of the electrophoretic medium composition. The two compositions, the aqueous sealing compositing and the electrophoretic medium composition, are thoroughly mixed and immediately coated onto the plurality of microcells with a precision coating mechanism such as Meyer bar, gravure, doctor blade, slot coating or slit coating. Excess fluid is scraped away by a wiper blade or a similar device. A small amount of a weak solvent or solvent mixture such as isopropanol, methanol or an aqueous solution thereof may be used to clean the residual fluid on the top surface of the microcell walls. The aqueous sealing composition is subsequently separated from the electrophoretic medium composition and floats on top of the electrophoretic medium liquid composition. Alternatively, after the mixture of the electrophoretic medium composition and the aqueous sealing composition is filled into the microcells, a substrate layer may be laminated on top to control the metering of the mixture of compositions and to facilitate the phase separation of the aqueous sealing composition from the electrophoretic medium composition to form a uniform sealing layer. The substrate layer used can be a functional substrate in the final structure or can be a sacrifice substrate sheet, for example, a release substrate sheet, which can be removed afterwards. A sealing layer is then formed by hardening the aqueous sealing composition in situ (i.e., when in contact with the electrophoretic medium composition). The hardening of the aqueous sealing composition may be accomplished by UV or other forms of radiation such as visible light, IR, or electron beam. Alternatively, heat or moisture may also be employed to harden the aqueous sealing composition if a heat or moisture curable aqueous sealing composition is used.

In another approach, the electrophoretic medium composition may be filled into the microcells first and an aqueous sealing composition is subsequently overcoated onto the filled microcells. The overcoating may be accomplished by a conventional coating and printing process, such as blanket coating, inkjet printing or other printing processes. A sealing layer, in this approach, is formed in situ, by hardening the aqueous sealing composition by solvent evaporation, radiation, heat, moisture, or an interfacial reaction. Interfacial polymerization followed by UV curing is beneficial to the sealing process. Intermixing between the electrophoretic medium composition and the sealing overcoat is significantly suppressed by the formation of a thin barrier layer at the interface by interfacial polymerization. The sealing is then completed by a post curing step, for example, by UV radiation. The degree of intermixing may be further reduced by using an aqueous sealing composition that has lower specific gravity than that of the electrophoretic medium composition. Volatile organic solvents may be used to adjust the viscosity and thickness of the sealing overcoat. The rheology of the aqueous sealing composition may be adjusted for optimal sealability and coatability. When a volatile solvent is used in the overcoat, it is preferred that it is immiscible with the solvent in the electrophoretic medium composition.

After the microcells are filled and sealed, the sealed array may be laminated with second electrode layer 250 comprising a plurality of electrodes. Second electrode layer 250 may be attached onto sealing layer 230 to form electro-optic device 990 as shown in FIG. 9D. An adhesive may be used to attach second electrode layer 250 onto sealing layer 230 (the adhesive layer is not shown in FIG. 9D. The adhesive may be electrically conductive. The adhesive of the adhesive layer, which may be a pressure sensitive adhesive, a hot melt adhesive, or a heat, moisture, or radiation curable adhesive. The laminate adhesive may be post-cured by radiation such as UV through the top conductive layer if the latter is transparent to the radiation. In other embodiments, the plurality of electrodes may be bonded directly to the scaled array of the microcell. FIG. 9D illustrates assembly 990 comprising filled and sealed microcells and first and second electrode layers (210 and 250).

In general, the microcells can be of any shape, and their sizes and shapes may vary. The microcells may be of uniform size and shape in one system. However, it is possible to have microcells of mixed shapes and sizes. The microcell openings may be round, square, rectangular, hexagonal or any other shape. The size of the partition area between the microcell openings may also vary. The dimension of each individual microcell may be in the range of about 1×10¹ to about 1×10⁶ μm², from about 1×10² to about 1×10⁶ μm², or from about 1×10³ to about 1×10⁵ μm².

The depth of the microcells may be in the range of about 5 to about 200 μm, or from about 10 to about 100 μm. The microcell opening to the total area ratio is in the range of from about 0.05 to about 0.95, or from about 0.4 to about 0.9.

### Electrophoretic Medium.

The electrophoretic medium, in the context of the present invention, refers to the composition which is included in the microcells or microcapsules. For display applications, the microcells or microcapsules may be filled with at least one type of charged pigment particles in a non-polar fluid. The electrophoretic medium may comprise one type of charged type of particles or more than one type of particles having different colors, charges, and charge polarities. The charged particles move through the electrophoretic medium under the influence of an electric field applied across the electro-optic material layer. The charged particles may be inorganic or organic pigments having polymeric surface treatments to improve their stability. The electrophoretic medium may comprise pigments having white, black, cyan, magenta, yellow, blue, green, red, and other colors. The electrophoretic medium may also comprise charge control agents, charge adjuvants, rheology modifiers, and other additives. Examples of non-polar fluids include hydrocarbons such as Isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzotri fluoride, chloropentafluoro-benzene, dichlorononane or pentachlorobenzene, and perfluorinated solvents such as FC-43, FC-70 or FC-5060 from 3M Company, St. Paul MN, low molecular weight halogen containing polymers such as poly(perfluoropropylene oxide) from TCI America, Portland, Oregon, poly(chlorotrifluoro-ethylene) such as Halocarbon Oils from Halocarbon Product Corp., River Edge, NJ, perfluoropolyalkylether such as Galden from Ausimont or Krytox Oils and Greases K-Fluid Series from DuPont, Delaware, polydimethylsiloxane based silicone oil from Dow-corning (DC-200).

The electrophoretic medium may comprise two or more types of charged particles. The electrophoretic medium may comprise four types of charged particles, a first, second type, third type, and fourth types of charged particles. The first, second, third, and fourth types of charged particles may comprise a first, second, third, and fourth types of pigment, having a first, second, third, and fourth color, respectively. First, second, third, and fourth colors may be different from each other. The first type of particles may comprise inorganic pigment and has a first charge polarity. The second and third types of particles may have a second charge polarity that is opposite to second charge polarity. The fourth type of particles may have first charge polarity or second charge polarity. The first type of particles may be white. The second, third, and fourth charged particles may have colors selected from the group consisting of cyan, magenta, and yellow.

### Sealing Layer

The microcells are sealed with sealing layer 230, which spans the microcell openings of the plurality of the microcells.

The sealing layer must provide a barrier to the electrophoretic medium so that the non-polar fluid will not be removed from the plurality of microcells. Furthermore, because the sealing layer is in contact with the electrophoretic medium and seals it inside the microcavities, it must be (1) practically insoluble in the non-polar fluid of the electrophoretic medium, and (2) a good barrier to the non-polar fluid, so that the non-polar fluid does not diffuse out form the microcells during the life of the device. Inferior barrier properties of the sealing layer towards the non-polar fluids lead to the reduction of the fluid from the electrophoretic medium and sagging of the sealing layer. In certain applications, where the electrophoretic device may be exposed to harsh conditions such as exposure to organic solvents or water or even submersion into such solvents, the sealing layer also needs to be water-resistant. That is, the sealing layer must be resilient to water and must protect the electrophoretic medium under such conditions.

### Aqueous Adhesive Composition.

The adhesive film of the intermediate electro-optic laminate and, subsequently, the first adhesive layer of the electro-optic device of the present invention is formed by an initial application of an aqueous adhesive composition onto the second electrode layer as shown in FIG. 5A. The application of the aqueous adhesive composition may take place by various coating or printing methodologies. The aqueous adhesive composition may comprise (a) from 20 weight percent to 80 weight percent polyurethane, a self-crosslinking acrylic polymer, or a combination of polyurethane and self-crosslinking acrylic polymer by weight of the aqueous adhesive composition excluding solvents, (b) from 20 weight percent to 80 weight percent poly(vinyl alcohol) by weight of the aqueous adhesive composition excluding solvents, the poly(vinyl alcohol) containing an acetoacetate functional group in its molecular structure, (c) from 10 weight percent to 90 weight percent of an aqueous carrier by weight of the aqueous adhesive composition. The aqueous adhesive composition may also comprise from 0.5 weight percent to 8 weight percent of a poly(vinyl alcohol) crosslinking agent by weight of the aqueous adhesive composition excluding solvents. The aqueous adhesive composition may also comprise from 0.3 weight percent to 2 weight percent light absorber by weight of the aqueous adhesive composition excluding solvents. The aqueous adhesive composition may also comprise from 0.1 weight percent to 0.8 weight percent light stabilizer by weight of the aqueous adhesive composition excluding solvents. The light stabilizer may be a hindered amine light stabilizer (HALS).

Polyurethanes are typically prepared via a polyadditional process involving a diisocyanate. Non-limiting examples of polyurethanes include polyether polyurethanes, polyester polyurethanes, polycarbonate polyurethanes, polyether polyureas, polyureas, polyester polyureas, polyester polyureas, polyisocyanates (e.g., polyurethanes comprising isocyanate bonds), and polycarbodiimides (e.g., polyurethanes comprising carbodiimide bonds). Generally, the polyurethane contains urethane groups. The polyurethane that is used in the aqueous adhesive composition may be prepared using methods known in the art. Preferably, the polyurethanes of the aqueous adhesive composition of the present inventions may be polyether polyester polyurethanes, polycarbonate polyurethanes, and mixtures thereof. In one example the polyurethane of the aqueous adhesive composition is an aliphatic polycarbonate polyurethane. In one example the polyurethane of the aqueous adhesive composition is an aqueous dispersion. The polyurethane may be crosslinked polyurethane or non-crosslinked polyurethane. The aqueous adhesive composition may comprise from 30 weight percent to 80 weight percent, or from 40 weight percent to 65 eight percent, or from 45 weight percent to 60 weight percent of polyurethane by weight of the aqueous adhesive composition excluding solvents. The polyurethane may have number average molecular weight from 1,000 to 2,000,000 Daltons, from 5,000 to 1,500,000 Daltons, from 10,000 to 1,000,000 Daltons, or from 30,000 to 800,000 Daltons. Non-limiting examples of commercial polyurethanes that can be used in the aqueous adhesive composition include Relca® PU-406 supplied by Stahl Polymers, Alberdingk® U6150 supplied by Alberdingk® Boley, Alberdingk U400N supplied by Alberdingk® Boley, HD2125 supplied by Hauthaway, Witcobond® W-281F supplied by Chemtura Corp., Dispercoll® U53, supplied by Covesto,

Self-crosslinking polymers contain a functional group which enables the reaction between polymer chains of the polymer (same or different molecules of the polymer), without the use of a separate reactant. The self-crosslinking polymer is usually in the form of an aqueous dispersion or emulsion and is typically the product of at least two monomers that react with one another. For example, such a polymer may contain both a carbonyl and an amine functional group or an epoxy functional group and a hydroxy, amine, or carboxyl functional group. A self-crosslinking acrylic polymer may be formed from one or more acrylic monomers, such as, for example, methyl acrylic acid, methyl methacrylate, butyl acrylate, butyl methacrylate, styrene, and methyl styrene.

The aqueous adhesive composition may comprise a weight ratio of self-crosslinking acrylic polymer to poly(vinyl alcohol) of from 0.15 to 0.30, from 0.18 to 0.28, or from 0.19 to 0.27.

The poly(vinyl alcohol) of the aqueous adhesive composition contains acetoacetyl functional groups in its molecular structure. The poly(vinyl alcohol) may have number average molecular weight from 1,000 to 1,000,000 Daltons. The poly(vinyl alcohol) may have a degree of hydrolysis of from 90 to 99 percent, or from 91 percent to 98 percent, or from 92 percent to 96 percent. The aqueous adhesive composition may comprise from 30 weight percent to 80 weight percent, or from 40 weight percent to 65 eight percent, or from 45 weight percent to 60 weight percent of poly(vinyl alcohol) by weight of the aqueous adhesive composition excluding solvents.

An example of poly(vinyl alcohol) that contains an acetoacetate functional group in its molecular structure is GOHSENX™ Z-410 supplied by Mitsubishi Chemical. This material is crosslinkable, and it can be crosslinked by thermal treatment or via exposure to UV radiation. Other commercially available examples of poly(vinyl alcohol) that contains an acetoacetate functional group in its molecular structure include GOHSENX™ Z-100, GOHSENX™ Z-200, GOHSENX™ Z-205, GOHSENX™ Z-210, GOHSENX™ Z-220, GOHSENX™ Z-300, and GOHSENX™ Z-320. The poly(vinyl alcohol) may be a copolymer formed via polymerization of vinyl alcohol and vinyl acetoacetate. The poly(vinyl alcohol) may be a terpolymer formed via polymerization of vinyl alcohol, vinyl acetate, and vinyl acetoacetate.

The aqueous adhesive composition may comprise a weight ratio of poly(vinyl alcohol) to polyurethane of from 4 to 0.4, from 3 to 0.3, or from 2 to 0.2, or from 1.5 to 0.7, or from 1.3 to 0.8, or from 1.2 to 0.85, or from 1.1 to 0.9.

The aqueous adhesive composition may comprise from 0.5 weight percent to 8 weight percent of a poly(vinyl alcohol) crosslinking agent by weight of the aqueous adhesive composition excluding solvents, from 0.2 weight percent to 8 weight percent, from 0.3 weight percent to 6 weight percent from 0.4 weight percent to 5 weight percent, from 0.5 weight percent to 4 weight percent, from 0.8 weight percent to 3 weight percent by weight of the aqueous adhesive composition excluding solvents. The crosslinked poly(vinyl alcohol) of the adhesive layer is formed by the reaction of poly(vinyl alcohol) and a crosslinking agent. Thus, the aqueous adhesive composition comprises a poly(vinyl alcohol) and a crosslinking agent. The crosslinking agent reacts with the poly(vinyl alcohol) at the hydroxyl groups or the acetoacetyl functional groups of the poly(vinyl alcohol). That is, the crosslinking agent reacts with two or more poly(vinyl alcohol) polymer molecules, forming bonds between the polymers. The crosslinking agent may have two or more reactive functional groups, such as alcohol, amine, and aldehyde. Non-limited typical examples of classes of crosslinking agents include diamines, polyamines, diols, polyols, dialdehydes, dihydrazides, organic titanates, organic zirconates, and organic borates. The crosslinker may be a saturated dialdehyde having 2 to 6 carbon atoms, such as glyoxal.

The quality of the adhesive layer of the electro-optic device of the present invention requires that the adhesive film of the intermediate electro-optic laminate includes a poly(vinyl alcohol), the acetoacetyl functional groups of which are not all crosslinked. That is, even if the aqueous adhesive composition comprises a crosslinking agent that can crosslink the poly(vinyl alcohol) via acetoacetyl functional groups, the poly(vinyl alcohol) of the adhesive film of the intermediate electro-optic laminate must still have acetoacetyl functional groups that are not crosslinked. Of course, if the aqueous adhesive composition does not contain such a crosslinker, the poly(vinyl alcohol) of the adhesive film contains acetoacetyl functional groups. Thus, in the case that the aqueous adhesive composition comprises a crosslinking agent, the stoichiometry of the aqueous adhesive composition must be controlled so that after the crosslinking of the poly(vinyl alcohol) to form the adhesive film, there are acetoacetyl functional groups remaining in the crosslinked poly(vinyl alcohol) of the adhesive film of the intermediate electro-optic laminate. These acetoacetyl functional groups will eventually be needed to react with the polar groups of the surface of the thermoplastic film of the second substrate layer to form a bond between the first adhesive layer and the thermoplastic film.

The aqueous adhesive composition must be a fluid having the appropriate viscosity so that it can be successfully applied onto the second electrode layer to form the adhesive film of the intermediate electro-optic laminate. A rheology modifier may be used in the aqueous adhesive composition to adjust the viscosity. In addition, the aqueous adhesive composition must have a sufficiently long pot life. In some cases, the poly(vinyl alcohol) crosslinking agent, the self-crosslinking acrylic resin, or other components of the aqueous adhesive composition may cause the viscosity of the aqueous adhesive composition to increase to a level that prevents its application onto the second electrode layer to form the adhesive film of the intermediate electro-optic laminate. Thus, care must be taken to formulate compositions that lead to aqueous adhesive composition having sufficiently long pot life. The aqueous adhesive composition may have pot life longer than 1 day, longer than 3 days, longer than 5 days, or longer than 7 days. Non-limiting examples of poly(vinyl alcohol) crosslinking agents that may provide long pot lives of aqueous adhesive compositions include Safelink™ SPM-01, supplied by Mitsubishi Chemical, glyoxal, and organic zirconates, such as ZrO(OH)Cl*nH₂O (supplied as ZIRCOZOL ZC-2 by Daiichi Kigenso Kagaku Kogyo Co., Ltd) and (NH₄)₂ZrO(CO₃)₂ (supplied as ZIRCOZOL AC-7 by Daiichi Kigenso Kagaku Kogyo Co., Ltd.

### Second Substrate Layer

The second substrate layer of the chemically-resistant electro-optic device of the present invention is formed by a thermoplastic film. The thermoplastic film that is used to form the second substrate layer may comprise a thermoplastic resin selected from a group consisting of polyethylene, polypropylene, polybutylene, polyethylene terephthalate, an ethylene copolymer, a propylene copolymer, a butylene copolymer, and mixtures thereof.

The second substrate layer must protect the electro-optic device from mechanical damage and also from diffusion of moisture and other materials into the device. In order to manufacture a chemically-resistant device, the second substrate layer must be strongly bonded to the adhesive layer. The inventors of the present invention found that strong adhesion between the second electrode and the second substrate layer can be achieved via adhesive layer, wherein the thermoplastic film of the second substrate layer is surface treated to include polar groups. These polar groups can form covalent bonds with acetoacetyl functional groups of the poly(vinyl alcohol) of the adhesive layer. Thus, the adhesive layer, which is formed by the crosslinking of the poly(vinyl alcohol) with a crosslinking agent, should contain non-crosslinked acetoacetyl functional groups. In other words, the crosslinking of the poly(vinyl alcohol) should be partial.

There are numerous methodologies for surface treating thermoplastic films that comprise thermoplastic resins such as polyethylene, polypropylene, polybutylene, an ethylene copolymer, a propylene copolymer, and a butylene copolymer. Non-limiting examples of the methodologies include corona treatment, flame treatment, plasma treatment, and chemical treatment, such as ozone treatment.

The electrophoretic display of the present invention may comprise a piezoelectric material layer comprising a piezoelectric material. Such electrophoretic display can be operated without the need for a power supply. This means that the structure of the electrophoretic display is simplified. The piezoelectric material layer may be positioned (a) between the electro-optic material layer and the first light-transmissive electrode layer, (b) between the electro-optic material layer and the second electrode layer, or (c) side-by-side next to the electro-optic material layer.

Piezoelectricity is the charge that accumulates in a solid material (piezoelectric material) in response to applied mechanical stress. Examples of piezoelectric materials include polyvinylidene fluoride (PVDF), quartz (SiO₂), berlinite (AlPO₄), gallium orthophosphate (GaPO₄), tourmaline, barium titanate (BaTiO₃), lead zirconate titanate (PZT), zinc oxide (ZnO), aluminum nitride (AlN), lithium tantalite, lanthanum gallium silicate, potassium sodium tartrate and any other known piezoelectric materials. The piezoelectric material layer may further comprise an ionic liquid.

Voltage generated by piezoelectricity may drive the pigments of an electrophoretic material layer to change the color or the image of the electrophoretic material when viewed from a viewing side of the display. For example, by bending or by introducing stress to an electro-optic display that comprises a piezoelectric material layer, voltage may be generated, and this voltage can be utilized to cause movement of the color pigments of the electrophoretic material.

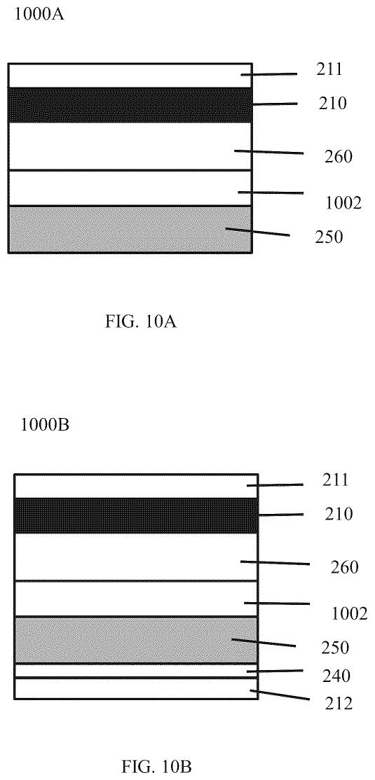

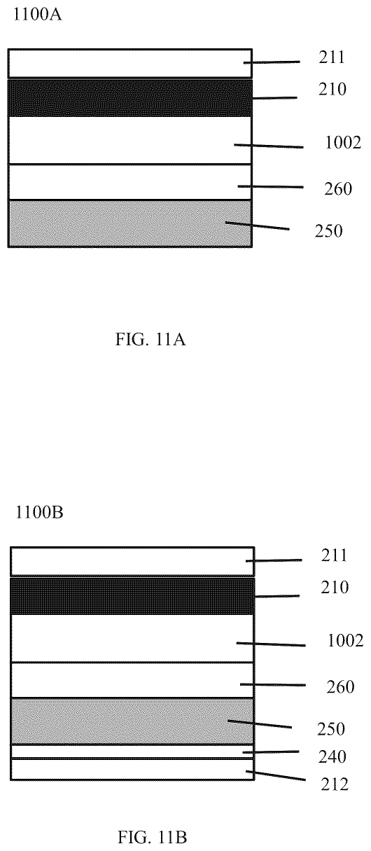

FIG. 10A shows an example of an electro-optic assembly comprising a piezoelectric material layer. FIG. 10A is a cross-sectional view of assembly 1000A comprising piezoelectric material layer 1002 that can drive electro-optic material layer 260. The electro-optic assembly comprises first substrate layer 211, first light-transmissive electrode layer 210, electro-optic material layer 260, piezoelectric material layer 1002, and second electrode layer 250. Piezoelectric material layer 1002 is located between second electrode layer 250 and electro-optic material layer 260, whereas electro-optic material layer 260 is disposed between first light-transmissive electrode layer 210 and piezoelectric material layer 1002. Electro-optic material layer 260 may comprise a plurality of microcells (not shown in FIG. 10A), each of the plurality of microcells including a microcell bottom, microcell walls, and a microcell opening, and containing an electrophoretic medium. A sealing layer (not shown in FIG. 10A) spans the microcell openings of the plurality of microcells. The sealing layer may be located adjacent to the piezoelectric layer 1002. The first light-transmissive electrode layer 210 may have the form of a single continuous electrode (also called conductive layer) and the second electrode layer 250 may comprise a plurality of pixel electrodes (matrix of pixel electrodes). Electro-optic assembly 1000A can be used to prepare an electro-optic device (1000B) by applying an aqueous adhesive composition onto the second electrode layer (250) according to the present invention, curing the aqueous adhesive composition to form an adhesive film, and attaching a thermoplastic film onto the adhesive film by hot stamping to form chemically-resistant electro-optic device 1000B, which is shown in FIG. 10B. Chemically-resistant electro-optic device 1000B of FIG. 10B comprises first substrate layer 211, first light-transmissive electrode layer 210, electro-optic material layer 260, piezoelectric material layer 1002, second electrode layer 250, first adhesive layer 240, and second substrate layer 212. The display may be bent by a user, generating a voltage that is sufficient to operate the display.

FIG. 11A illustrates a cross-sectional view of another example of electro-optic assembly 1100A comprising piezoelectric material layer 1002 that can drive electro-optic material layer 260. The electro-optic assembly comprises first substrate layer 211, first light-transmissive electrode layer 210, piezoelectric material layer 1002, electro-optic material layer 260, and second electrode layer 250. Piezoelectric material layer 1002 is located between first light-transmissive electrode layer 210 and electro-optic material layer 260, whereas electro-optic material layer 260 is disposed between second electrode layer 250 and piezoelectric material layer 1002. Electro-optic material layer 260 may comprise a plurality of microcells (not shown in FIG. 11A), each of the plurality of microcells including a microcell bottom, microcell walls, and a microcell opening, and containing an electrophoretic medium. A sealing layer (not shown in FIG. 11A) spans the microcell openings of the plurality of microcells. The sealing layer may be located adjacent to second electrode layer 250. The sealing layer may be located adjacent to second electrode layer 250. The electro-optic assembly may further comprise an adhesive layer (not shown in FIG. 11A), the adhesive layer being disposed between electro-optic material layer 260 and second electrode layer 250. The first light-transmissive electrode layer 210 may have the form of a single continuous electrode (also called conductive layer) and the second electrode layer 250 may comprise a plurality of pixel electrodes (matrix of pixel electrodes). Electro-optic assembly 1100A can be used to prepare a chemically-resistant electro-optic device (1100B) by applying an aqueous adhesive composition onto the second electrode layer according to the present invention, curing the aqueous adhesive composition to form an intermediate electro-optic laminate comprising an adhesive film, and attaching a thermoplastic film onto the adhesive film of the intermediate electro-optic laminate by hot stamping. Chemically-resistant electro-optic device 1100B of FIG. 11B comprises first substrate layer 211, first light-transmissive electrode layer 210, piezoelectric material layer 1002, electro-optic material layer 260, second electrode layer 250, first adhesive layer 240, and second substrate layer 212. The display may be bent by a user, generating a voltage that is sufficient to operate the display.

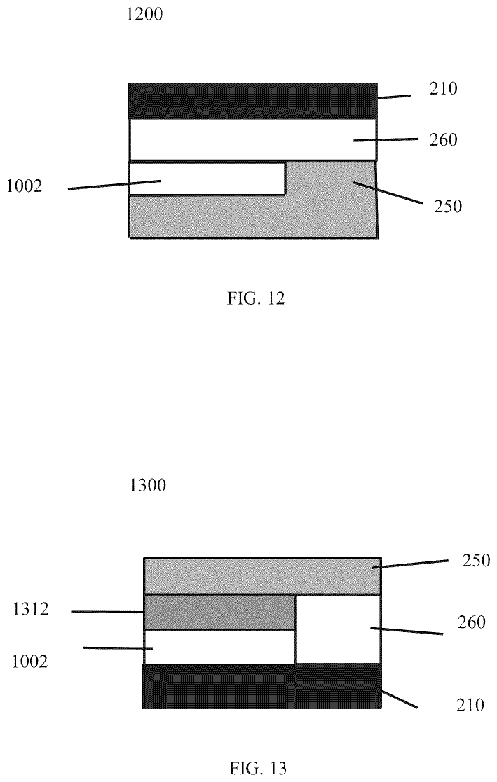

FIG. 12 illustrates a cross-sectional view of an example of electro-optic assembly 1200 comprising (1) piezoelectric material layer 1002 that can drive electro-optic material layer 260 and (2) a sealing layer. The electro-optic assembly comprises first light-transmissive electrode layer 210, electro-optic material layer 260, piezoelectric material layer 1002, and second electrode layer 250. In this embodiment, piezoelectric material layer 1002 is positioned between electro-optic material layer and second electrode layer 250. Piezoelectric material layer 1002 overlaps with only a first portion of electrophoretic material layer 260. Second electrode layer 250 overlaps with all piezoelectric material layer 1002 and a second portion of electro-optic material layer, wherein the second portion of electro-optic material layer does not overlap with piezoelectric material layer 1002. The first portion of electro-optic material layer may comprise a first plurality of microcells (not shown in FIG. 12) and may have a first electrical resistance, while the second portion of electro-optic material layer may comprise a second plurality of microcells (not shown in FIG. 12) and may have a second electrical resistance. First light-transmissive electrode layer 210 is adjacent to electro-optic material layer 260 and opposite to the side of the electro-optic material layer 260 that is in contact with piezoelectric material layer 1002 and second electrode layer 250 as illustrated in FIG. 12. Each of the first and second plurality of microcells includes a microcell bottom, microcell walls, and a microcell opening, and containing an electrophoretic medium. A sealing layer (not shown in FIG. 12) spans the microcell openings of the first and second plurality of microcells. The sealing layer may be located adjacent to piezoelectric material layer 1002 and second electrode layer 250 (on the side of the electro-optic material layer that is opposite to first light-transmissive electrode layer 210). Electro-optic assembly 1200 can be used to prepare a chemically resistant electro-optic device by applying an aqueous adhesive composition onto the second electrode layer according to the present invention, curing the aqueous adhesive composition, and attaching a thermoplastic film by hot stamping.

In another example, instead of having a piezoelectric material layer directly laminated onto or overlapping with an electro-optic material layer as shown in FIGS. 10A, 11A and 12, a piezoelectric material layer 1002 may be laminated onto a semi-conductive or high-resistive layer 1312, and then semi-conductive or high-resistive layer 1312 is laminated on first light-transmissive electrode layer 210, as shown in FIG. 13. In this configuration, electro-optic assembly 1300 comprises a semi-conductive or high-resistive layer 1312. The semi-conductive or high-resistive layer 1312 replaces portions of electro-optic material layer 260 on top of piezoelectric material layer 1002, thereby reducing the overall thickness of the display, as well as preventing a fast dissipation of charges across the piezoelectric material layer 1002 so the locally produced charges (by the piezoelectric material layer 1002) may be effectively and efficiently applied onto electro-optic material layer 260. This results in an improvement in the display contrast ratio. First light-transmissive electrode layer 210 and second electrode layer 250 sandwich electro-optic material layer 260, semi-conductive or high-resistive layer 1312, and piezoelectric material 1002 layers as shown in FIG. 13. Electro-optic material layer 260 may comprise a plurality of microcells (not shown in FIG. 13), each of the plurality of microcells including a microcell bottom, microcell walls, and a microcell opening, and containing an electrophoretic medium. A sealing layer (not shown in FIG. 13) may span the microcell openings of the plurality of microcells. The sealing layer (not shown in FIG. 13) may be located adjacent to first light-transmissive electrode layer 210. The sealing layer (not shown in FIG. 13) may be located adjacent to second electrode layer 250. Electro-optic assembly 1300 can be used to prepare a chemically-resistant electro-optic device by applying an aqueous adhesive composition onto the second electrode layer (250) according to the present invention, curing the aqueous adhesive composition, and attaching a thermoplastic film by hot stamping.

In another example, FIG. 14 illustrates a cross-sectional view of electro-optic assembly 1400 that comprises a piezoelectric layer and a sealing layer. Assembly 1400 differs from the assembly illustrated in FIG. 13 in that only a portion of piezoelectric material layer 1002 overlaps with first light-transmissive electrode layer 210. In this configuration, piezoelectric material layer 1002 can avoid being placed in a neutral plane position, such that better images may be generated from piezoelectric material layer 1002. In addition, piezoelectric material layer 1002 may be a metalized piezoelectric material layer and may be covered by a metal layer 1413. In some embodiment, first semi-conductive layer 1312 may be positioned between metal layer 1413 and first light-transmissive electrode layer 210. Another semi-conductive layer, second semi-conductive layer 1410, may be positioned between piezoelectric material layer 1002 and second electrode layer 250. It should be appreciated that all the layers presented herein, including first light-transmissive electrode layer 210 and second electrode layer 250 may be light-transmissive, such that the final device may be viewed from either direction or orientation. Electro-optic material layer 260 may comprise a plurality of microcells (not shown in FIG. 14), each of the plurality of microcells including a microcell bottom, microcell walls, and a microcell opening, and containing an electrophoretic medium. A sealing layer (not shown in FIG. 14) spans the microcell openings of the plurality of microcells. The sealing layer (not shown in FIG. 14) may be located adjacent to second electrode layer 250. The sealing layer (not shown in FIG. 14) may be located adjacent to second semi-conductive layer 1410. Electro-optic assembly 1400 can be used to prepare a chemically-resistant electro-optic device by applying an aqueous adhesive composition onto the second electrode layer according to the present invention, curing the aqueous adhesive composition, and attaching a thermoplastic film by hot stamping.

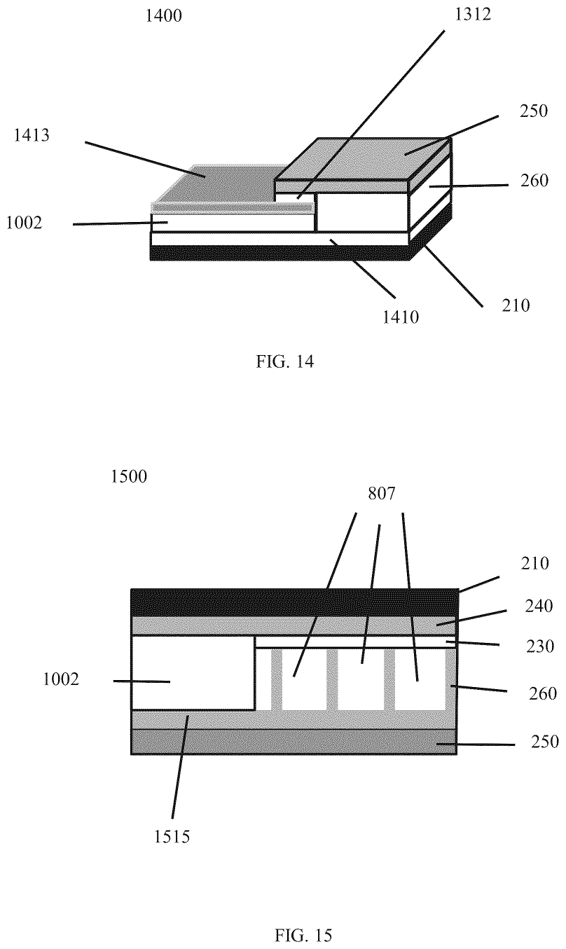

FIG. 15 illustrates a cross-sectional view of yet another example of an electro-optic assembly 1500. Electro-optic assembly 1500 comprises a piezoelectric material layer and a sealing layer. As shown in FIG. 15, electro-optic material layer 260 may partially extend underneath piezoelectric material layer 1002 to overlap, ensuring a secured connection with piezoelectric material layer 1002. In this example, electro-optic display layer 260 may have one portion having microcells 807 and another portion 1515 that is substantially flat and configured for establishing a connection with piezoelectric material layer 1002. In this configuration, piezoelectric material layer 1002 is positioned to overlap on the substantially flat portion 1515, ensuring a good connection with electro-optic material layer 260. This configuration can advantageously establish a strong connection between piezoelectric material layer 1002 and electro-optic material layer 260. For example, this configuration offers a robust connection between piezoelectric material layer 1002 and electro-optic material layer 260 that is capable of withstanding repeated bending or applied stress onto electro-optic display 1500. Additionally, a first adhesive layer 240 may be placed between piezoelectric material layer 1002 and first light-transmissive electrode layer 210. Each of microcells 807 comprise a microcell opening and sealing layer 230 spans each microcell opening. Furthermore, a second electrode layer 250 is adjacent to electro-optic material layer 260. Electro-optic assembly 1500 can be used to prepare a chemically-resistant electro-optic device by applying an aqueous adhesive composition onto the second electrode layer according to the present invention, curing the aqueous adhesive composition, and attaching a thermoplastic film by hot stamping.

### Examples

Preparation of electro-optic sheet: An electro-optic sheet was prepared comprising, in order, a first substrate layer, a first light-transmissive electrode layer, the first light-transmissive electrode layer comprising Indium tin oxide, an electro-optic material layer, and a second electrode layer comprising poly(3,4-ethylenedioxythiophene) polystyrene sulfonate (conductive polymer). The electro-optic material layer comprises a plurality of microcells. Each microcell comprises a microcell bottom, microcell walls, a microcell opening, and a sealing layer. The sealing layer spans the microcell opening. The sealing layer is in contact with the second electrode layer. A side view of the electro-optic sheet is illustrated in FIG. 3A.

Preparation of an aqueous adhesive composition: An aqueous adhesive composition was prepared by mixing the ingredients of the aqueous adhesive composition. The aqueous adhesive compositions are provided in Tables 1 and 2. The contents of the aqueous adhesive compositions of Table 1 represent the weight of active material. That is, they do not include solvents in the ingredients.

Preparation of an intermediate electro-optic laminate: Each of the aqueous adhesive compositions was coated onto the second electrode layer of a separate electro-optic sheet and exposed to a temperature of from 80° C. to 100° C. for 3 hours to cure to aqueous adhesive composition to form an adhesive film on the second electrode and to form the intermediate electro-optic laminate. The adhesive layer of the intermediate electro-optic laminate was not tacky, and the intermediate electro-optic laminate could be rolled into a web. A side view of the intermediate electro-optic laminate is illustrated in FIG. 4A.

Preparation of electro-optic device: The adhesive layer of each of the prepared intermediate electro-optic laminates was aligned with a thermoplastic film and exposed to a hot stamping press at temperature of 95° C. and pressure of from 1 MPa to 50 MPa for 0.5 seconds to form an electro-optic device. The thermoplastic film comprised polypropylene that was surface treatment to form polar groups on the surface of the thermoplastic film. The adhesive strength of the first adhesive layer of the device was determined as described below. A side view of the intermediate electro-optic laminate is illustrated in FIG. 2A.

### Evaluations.

The pot life of the aqueous adhesive compositions were evaluated at 25° C. The pot life was evaluated as a time that the aqueous adhesive composition remained able to be coated on a surface.

The chemical resistances of the electro-optic device were evaluated by submersing the device in a solvent or in an aqueous solution under certain conditions for a certain time and then evaluating the adhesion strength of the adhesive layer. Specifically, chemical resistances of the electro-optic device were evaluated by (a) submerging the device in toluene at room temperature for 5 hours; (b) submerging the device in ethanol at room temperature for 5 hours; (c) submerging the device in acetone at room temperature for 5 hours; (d) submerging the device in water at a temperature of 100° C. for 30 minutes; (e) submerging the device in water at a temperature of 100° C. for 2 hours; (f) submerging the device in 0.1M solution of HCl at 25° C. for 2 hours; (g) submerging the device in 0.1M solution of acetic acid at 25° C. for 2 hours: (h) submerging the device in 0.1M solution of NH₄OH at 25° C. for 4 hours.

The adhesive resistance of the adhesive layer on the second electrode was evaluated by measuring the required force to separate the layer at 180° angle at 5 mm/s according to ASTM D093 method.

TABLE 1
Aqueous adhesive compositions that contain polyurethane,
poly(vinyl alcohol) and crosslinking agent. The contents
of the components of the aqueous adhesive compositions represent
the percent weight of active material by weight of the aqueous
adhesive composition excluding water and other solvents.
The weight percent content of a components
does not include solvents (including water) in the raw material.

| | Contents | | |
|---|---|---|---|
| Components | Ex. 1 | Ex. 2 | Ex. 3 |
| Polyurethane Dispersion [1] | 48.0 | | 48.0 |
| Polyurethane Dispersion [2] | | 48.0 | |
| Poly(vinyl alcohol) | 48.0 | 48.0 | |
| containing reactive | | | |
| acetoacetyl functional groups [3] | | | |
| Poly(vinyl alcohol) | | | 48.0 |
| containing reactive | | | |
| acetoacetyl functional groups [4] | | | |
| Crosslinking agent for | 3.0 | 3.0 | 3.0 |
| crosslinking poly(vinyl | | | |
| alcohol) [5] | | | |
| Water based UV absorber [6] | 0.5 | 0.5 | 0.5 |
| Hindered Amine Light | 0.5 | 0.5 | 0.5 |
| Stabilizer (HALS) [7] | | | |
| Water and other solvents [15] | Q.S | Q.S | Q.S |
| Adhesion strength of adhesive | Higher | Higher | Higher |
| layer on thermoplastic | than 16 | than 16 | than 16 |
| polymer of the final | | | |
| electro-optic device (in N/in) | | | |

[1] Alberdingk ® U6150, aliphatic carbonate polyurethane aqueous dispersion, supplied by Alberdingk Boley.
[2] Relca PU-406, aliphatic carbonate polyurethane aqueous dispersion, supplied by Stahl.
[3] GOHSENX ™ Z320, supplied by Mitsubishi Chemical.
[4] GOHSENX ™ Z410, supplied by Mitsubishi Chemical.
[5] Safelink ™ SPM-01 Glyoxylate salt, supplied by Mitsubishi Chemical; stoichiometry of the crosslinking agent was such that the poly(vinyl alcohol) is only partially crosslinked at the stage of the intermediate electro-optic laminate.
[6], [7] EVERSORB ® AQ1 comprising both UV absorber and HALS.
[15] A small content of an organic solvent may be present as impurity and/or as part of the carrier of a component, as supplied by the manufacturer.

Aqueous adhesive compositions of Table 1 comprise (a) poly(vinyl alcohol) having acetoacetyl functional groups, (b) a polyurethane, and (c) a crosslinking agent (for poly(vinyl alcohol). The stoichiometry of the aqueous adhesive compositions enable the formation of an intermediate electro-optic laminate comprising a partially crosslinked poly(vinyl alcohol) and an electro-optic device having a strong adhesion between the second substrate layer, the surface of which comprises polar functional groups, and the first adhesive layer and between the second electrode layer (comprising poly(3,4-ethylenedioxythiophene) polystyrene sulfonate and the first adhesive layer. In addition, the intermediate electro-optic laminate can be stored as a web, because the adhesive film of the intermediate electro-optic laminate is not tacky. It was observed that, if the adhesive film of the intermediate electro-optic laminate comprises a fully crosslinked poly(vinyl alcohol), the final electro-optic device has deficient properties, which is not strong adhesion strength between the first adhesive layer and the second substrate layer.

TABLE 2
Aqueous adhesive compositions that contain polyurethane,
poly(vinyl alcohol), but no crosslinking agent and chemical
resistance in organic solvents. The contents of the components
of the aqueous adhesive compositions represent the percent
weight of active material by weight of the aqueous adhesive
composition excluding water and other solvents.
The weight percent content of a components does not
include solvents (including water) in the raw material.

| Components | Ex. 4 | Ex. 5 | Ex. 6 | Ex. 7 |
|---|---|---|---|---|
| Polyurethane dispersion [8] | 48.0 | 48.0 | | |
| Polyurethane dispersion [1] | | | 48.0 | |
| Self-crosslinking acrylic | | | | 18.0 |
| polymer [9] | | | | |
| Self-crosslinking | | | | |
| acrylic polymer [10] | | | | |
| Polyurethane hybrid [11] | | | | |
| Styrene-butadiene | | | | |
| copolymer [12] | | | | |
| Poly(vinyl alcohol) | 48.0 | | 48.0 | 78.0 |
| containing reactive acetoacetyl | | | | |
| functional groups [3] | | | | |
| Poly(vinyl alcohol) | | 48.0 | | |
| containing reactive acetoacetyl | | | | |
| functional groups [4] | | | | |
| Rheological modifier [13] | 2.0 | 2.0 | 2.0 | 2.0 |
| Water based UV absorber [6] | 1.5 | 1.5 | 1.5 | 1.5 |
| Hindered Amine Light | 0.5 | 0.5 | 0.5 | 0.5 |
| Stabilizer (HALS) [7] | | | | |
| Water and solvents [15] | Q.S | Q.S | Q.S | Q.S |
| Adhesion strength of | Higher | Higher | Higher | Higher |
| adhesive layer on stamped | than 16 | than 16 | than 16 | than 16 |
| substrate layer (in N/in) | | | | |
| Adhesion strength | Higher | Higher | Higher | Higher |
| of adhesive layer after | than 16 | than 16 | than 16 | than 16 |
| submersion in toluene at | | | | |
| 25° C. for 5 hours (in N/in) | | | | |
| Adhesion strength | Higher | Higher | Higher | Higher |
| of adhesive layer after | than 16 | than 16 | than 16 | than 16 |
| submersion in ethanol at | | | | |
| 25° C. for 5 hours (in N/in) | | | | |
| Adhesion strength | Higher | Higher | Higher | Higher |
| of adhesive layer after | than 16 | than 16 | than 16 | than 16 |
| submersion in acetone at | | | | |
| 25° C. for 5 hours (in N/in) | | | | |

| | | Com- | |
|---|---|---|---|
| | | parative | Comparative |
| Components | Ex. 8 | Ex. 9 | Ex. 10 |
| Polyurethane dispersion [9] | | | |
| Polyurethane dispersion [1] | | | |
| Self-crosslinking acrylic | | | |
| polymer [10] | | | |
| Self-crosslinking acrylic | 18 | | |
| polymer [11] | | | |
| Polyurethane hybrid [12] | | 96 | |
| Styrene-butadiene | | | 96 |
| copolymer [13] | | | |
| Poly(vinyl alcohol) containing | 78 | | |
| reactive acetoacetyl | | | |
| functional groups [3] | | | |
| Poly(vinyl alcohol) containing | | | |
| reactive acetoacetyl | | | |
| functional groups [4] | | | |
| Rheological modifier [13] | 2 | 2 | 2 |
| Water based UV absorber [6] | 1.5 | 1.5 | 1.5 |
| Hindered Amine Light Stabilizer | 0.5 | 0.5 | 0.5 |
| (HALS) [7] | | | |
| Water and other solvents [15] | Q.S | Q.S | Q.S |
| Adhesion strength of | Higher | 4 | 4 |
| adhesive layer on stamped | | | |
| substrate layer (in N/in) | than 16 | | |
| Adhesion strength of adhesive | Higher | Lower | Lower than 1 |
| layer after submersion in toluene | than 16 | than 1 | |
| at 25° C. for 5 hours (in N/in) | | | |
| Adhesion strength of adhesive | Higher | 4 | 4 |
| layer after submersion in ethanol | than 16 | | |
| at 25° C. for 5 hours (in N/in) | | | |
| Adhesion strength of | Higher | Lower | Lower than 1 |
| adhesive layer after submersion | than 16 | than 1 | |
| n in acetone | | | |
| at 25° C. for 5 hours (in N/in) | | | |

[1] Alberdingk ® U6150, supplied by Alberdingk Boley.
[3] GOHSENX ™ Z320, supplied by Mitsubishi Chemical.
[4] GOHSENX ™ Z410, supplied by Mitsubishi Chemical.
[6], [7] EVERSORB ® AQ1 comprising both UV absorber and HALS.
[8] Alberdingk ® U6100, supplied by Alberdingk Boley.
[9] Alberdingk ® AC3600, supplied by Alberdingk Boley.
[10] Alberdingk ® AC3660, supplied by Alberdingk Boley.
[11] HS4305, supplied by Henkel.
[12] F9022N, supplied by Henkel.
[13] Hydrophobically modified alkali-soluble acrylic emulsion (HASE); Solthix A100, Lubrizol.
[15] A small content of an organic solvent may be present as impurity and/or as part of the carrier of a component, as supplied by the manufacturer.

Table 2 shows that inventive electro-optic devices formed by inventive aqueous adhesive compositions (Ex. 4 to Ex. 8) have first adhesive layer with higher adhesion strength under a variety of conditions than comparative electro-optic devices. The inventive aqueous adhesive compositions comprise a combination of (i) polyurethane or self-crosslinking acrylic polymer, and a poly(vinyl alcohol) comprising acetoacetyl functional groups.

TABLE 3
Comparison of pot life and adhesion strength of
inventive electro-optic devices after submersion in aqueous solutions.

| Condition | Ex. 4 | Ex. 5 | Ex. 6 |
|---|---|---|---|
| Submersion in water | 6 | 6 | Lower than 1 |
| at 100° C. for 30 | | | |
| minutes (in N/in) | | | |
| Submersion in water | Lower than 1 | Lower than 1 | Lower than 1 |
| at 100° C. for 2 | | | |
| hours (in N/in) | | | |
| Submersion in a 0.1M | Higher than | Higher than | Higher than |
| solution of HCl at 25° C. | 16 | 16 | 16 |
| for 2 hours (in N/in) | | | |
| Submersion in a 0.1M | Higher than | 3 | Lower than 1 |
| solution of acetic acid at | 16 | | |
| 25° C. for 4 hours (in N/in) | | | |
| Submersion in a 0.1M | Higher than | Higher than | Higher than |
| solution of NaOH at 25° C. | 16 | 16 | 16 |
| for 2 hours (in N/in) | | | |
| Submersion in a 0.1M | Higher than | 3 | Lower than 1 |
| solution of NH₄OH at 25° C. | 16 | | |
| for 4 hours (in N/in) | | | |
| Submersion in a toluene | Higher than | Higher than | Higher than |
| solution at 25° C. for | 16 | 16 | 16 |
| 5 hours (in N/in) | | | |
| Submersion in an ethanol | Higher than | Higher than | Higher than |
| solution at 25° C. for | 16 | 16 | 16 |
| 5 hours (in N/in) | | | |
| Submersion in acetone | Higher than | Higher than | Higher than |
| solution at 25° C. for | 16 | 16 | 16 |
| 5 hours (in N/in) | | | |
| Pot Life in days | 180 | 180 | 180 |

| Condition | Ex. 7 | Ex. 8 |
|---|---|---|
| Submersion in water at | Higher than | Higher than |
| 100° C. for 30 minutes | 16 | 16 |
| (in N/in) | | |
| Submersion in water at | Higher than | Higher than |
| 100° C. for 2 hours (in N/in) | 16 | 16 |
| Submersion in a 0.1M | Higher than | Higher than |
| solution of HCl at 25° C. | 16 | 16 |
| for 2 hours (in N/in) | | |
| Submersion in a 0.1M | Higher than | Higher than |
| solution of acetic acid at | 16 | 16 |
| 25° C. for 4 hours (in N/in) | | |
| Submersion in a 0.1M | Higher than | Higher than |
| solution of NaOH at 25° C. | 16 | 16 |
| for 2 hours (in N/in) | | |
| Submersion in a 0.1M | Higher than | Higher than |
| solution of NH₄OH at | 16 | 16 |
| 25° C. for 4 hours (in N/in) | | |
| Submersion in a toluene | Higher than | Higher than |
| solution at 25° C. for | 16 | 16 |
| 5 hours (in N/in) | | |
| Submersion in an ethanol | Higher than | Higher than |
| solution at 25° C. for | 16 | 16 |
| 5 hours (in N/in) | | |
| Submersion in acetone | Higher than | Higher than |
| solution at 25° C. for | 16 | 16 |
| 5 hours (in N/in) | | |
| Pot Life in days | 30 | 30 |

Table 3 shows that inventive electro-optic device with first adhesive layers comprising a combination of self-crosslinking acrylic polymer and poly(vinyl alcohol) have improved properties in term of water resistance compared to inventive electro-optic device with first adhesive layers comprising a combination of a polyurethane and poly(vinyl alcohol). It was also observed that the adhesion strength of the first adhesive layer (with the second substrate layer and the second electrode layer) was higher when the weight ratio of self-crosslinking acrylic polymer to poly(vinyl alcohol) was from 0.15 to 0.30. In addition, the pot lives of the inventive aqueous adhesive compositions were acceptably long.

TABLE 4
Aqueous adhesive compositions comprising
poly(vinyl alcohol) containing reactive acetoacetyl functional groups and
polyurethanes of various transition temperatures.

| Components | Ex. 4 | Ex. 6 | Ex. 11 |
|---|---|---|---|
| Polyurethane Dispersion [8] | 48 | | |
| Polyurethane Dispersion [1] | | 48 | |
| Polyurethane Dispersion [14] | | | 48 |
| Poly(vinyl alcohol) containing reactive | 48 | 48 | 48 |
| acetoacetyl functional groups [3] | | | |
| Rheological modifier [9] | 2.0 | 2.0 | 2.0 |
| Water based UV absorber [6] | 1.5 | 1.5 | 1.5 |
| Hindered Amine Light | 0.5 | 0.5 | 0.5 |
| Stabilizer (HALS) [7] | | | |
| Water and other solvents [15] | Q.S | Q.S | Q.S |
| Glass transition temperature of | Lower | Lower | Lower than |
| polyurethane (in ° C.) | than −40 | than 0 | 25 |
| Required hot stamping | 80-90 | 90-100 | 100-110 |
| temperature in degrees | | | |
| C. applied for 0.5 seconds | | | |
| to achieve adhesion | | | |
| strength of 16N/in or larger | | | |

[1] Alberdingk ® U6150, supplied by Alberdingk Boley.
[3] GOHSENX ™ Z320, supplied by Mitsubishi Chemical.
[8] Alberdingk ® U6100, supplied by Alberdingk Boley.
[6], [7] EVERSORB ® AQ1 comprising both UV absorber and HALS.
[9] Hydrophobically modified alkali-soluble acrylic emulsion (HASE); Solthix A100, Lubrizol.
[14] Alberdingk ® U9190, supplied by Alberdingk Boley.
[15] A small content of an organic solvent may be present as impurity and/or as part of the carrier of a component, as supplied by the manufacturer.

Table 4 shows that the hot stamping temperature to achieve a very strong adhesion layer of the first adhesive layer is lower when the polyurethane of the first adhesive layer has glass transmission temperature (Tg) of −30° C. or lower. That is, lower Tg facilitate the hot stamping process step.

Reference numbers in drawings: 100 Plurality of electrodes; 101 microcell bottom; 102 microcell walls; 103 microcell opening; 200 electro-optic device comprising microcells; 205 viewing side of device; 210 first light-transmissive electrode layer; 211 first substrate layer; 212 second substrate layer; 220 microcell layer; 225 electrophoretic medium; 230 sealing layer; 240 first adhesive layer; 242 aqueous adhesive composition; 245 adhesive film; 248 second adhesive layer in electro-optic device comprising microcapsules; 250 second electrode layer; 260 electro-optic material layer comprising microcells; 265 electro-optic material layer comprising microcapsules; 290 electro-optic device comprising microcapsules; 300 electro-optic sheet comprising microcells; 390 electro-optic sheet comprising microcapsules; 400 intermediate electro-optic laminate comprising microcells; 400 intermediate electro-optic laminate comprising microcapsules; 610 hot stamping stage; 620 web of electro-optic device; 700 male bond; 701 conductor film; 702 thermoplastic or thermoset precursor layer; 703 microcell array; 704 web; 800 microcell array; 801 radiation curable material for forming microcells; 802 conductor film; 803 substrate layer; 804 opaque areas of photomask; 805 transparent area of photomask; 806 photomask; 807 microcell; 814 lines of photomask; 815 spaces between lines of photomask; 816 second photomask; 900 microcell array comprising first light-transmissive electrode layer; 970 filled microcells comprising first light-transmissive electrode layer; 980 filled and sealed microcells comprising first light-transmissive electrode layer; 990 filled and sealed microcells comprising electrodes; 1000 assembly type comprising piezoelectric material layer; 1002 piezoelectric material layer; 1100 assembly type comprising piezoelectric material layer; 1200 assembly type comprising piezoelectric material layer; 1300 assembly type comprising piezoelectric material layer; 1312 semi-conductive or high-resistive layer; 1300 assembly type comprising piezoelectric material layer; 1410 second semi-conductive; 1413 metal layer; 1500 assembly type comprising piezoelectric material layer; 1515 flat portion of microcell layer.

### CLAUSES

Clause 1: A chemically-resistant multi-layered electro-optic device comprising, in order, a first substrate layer, a first light-transmissive electrode layer, an electro-optic material layer, a second electrode layer, a first adhesive layer, and a second substrate layer, the first adhesive layer comprising from 20 to 80 weight percent of a polyurethane, a crosslinked acrylic polymer, or a mixture of a polyurethane and a crosslinked acrylic polymer by weight of the first adhesive layer excluding solvents, from 20 to 80 weight percent of a poly(vinyl alcohol) by weight of the first adhesive layer excluding solvents, the poly(vinyl alcohol) containing acetoacetyl functional groups in its molecular structure; the second substrate layer being formed using a thermoplastic film having a surface, the thermoplastic film comprising a thermoplastic resin, the thermoplastic film having a surface treatment such that the surface of the thermoplastic film comprises polar functional groups, wherein at least a portion of the polar functional groups are covalently bonded to the poly(vinyl alcohol) of the first adhesive layer, the covalent bonds being formed from a reaction between the acetoacetyl functional groups of the poly(vinyl alcohol) and the polar functional groups of the surface of the thermoplastic film.

Clause 2: The chemically-resistant multi-layered electro-optic device of clause 1, wherein the electro-optic material layer comprises an electrophoretic medium, the electrophoretic medium comprising electrically charged pigment particles, a charge control agent, and a non-polar liquid, the electrophoretic medium being encapsulated in a plurality of microcells or in a plurality of microcapsules.

Clause 3: The chemically-resistant multi-layered electro-optic device of clause 2, wherein each microcell of the plurality of microcells comprises a microcell bottom, microcell walls, a microcell opening, and a sealing layer, the sealing layer spanning the microcell opening, the sealing layer being in contact with the second electrode layer.

Clause 4: The chemically-resistant multi-layered electro-optic device according to any one of clause 1 to clause 3, wherein the second electrode layer comprises a conductive polymer.

Clause 5: The chemically-resistant multi-layered electro-optic device of clause 4, wherein the conductive polymer is selected from the group consisting of poly(3,4-ethylenedioxythiophene) polystyrene sulfonate (PEDOT-PSS), polyacetylene, polyphenylene sulfide, polyphenylene vinylene and combinations thereof.

Clause 6: The chemically-resistant multi-layered electro-optic device according to any one of clause 1 to clause 5, wherein the thermoplastic film that is used to form the second substrate layer comprises a thermoplastic resin selected from a group consisting of polyethylene, polypropylene, polybutylene, polyethylene terephthalate, an ethylene copolymer, a propylene copolymer, a butylene copolymer, and mixtures thereof.

Clause 7: The chemically-resistant multi-layered electro-optic device according to any one of clause 1 to clause 6, wherein the first adhesive layer comprises a polyurethane or a mixture of a polyurethane and a crosslinked acrylic polymer, and wherein the polyurethane has a glass transition temperature lower than −30° C.

Clause 8: The chemically-resistant multi-layered electro-optic device according to any one of clause 1 to clause 7, wherein the first adhesive layer comprises a polyurethane or a mixture of a polyurethane and a crosslinked acrylic polymer, and wherein the polyurethane is crosslinked.

Clause 9: The chemically-resistant multi-layered electro-optic device according to any one of clause 1 to clause 8, wherein the poly(vinyl alcohol) is crosslinked, the crosslinked poly(vinyl alcohol) being formed by a reaction between the poly(vinyl alcohol) and a crosslinking agent.

Clause 10: The chemically-resistant multi-layered electro-optic device of clause 9, wherein the crosslinking agent is selected from the group consisting of dialdehyde, diamine, and organic zirconate.

Clause 11: The chemically-resistant multi-layered electro-optic device according to any one of clause 1 to clause 10, wherein the poly(vinyl alcohol) has a degree of hydrolysis of from 90 to 99 percent.

Clause 12: The chemically-resistant multi-layered electro-optic device according to any one of clause 1 to clause 11, wherein the first adhesive layer comprises a crosslinked acrylic polymer or a mixture of a polyurethane and a crosslinked acrylic polymer, the crosslinked acrylic polymer being formed by crosslinking of a self-crosslinking acrylic polymer comprising an epoxy functional group.

Clause 13: The chemically-resistant multi-layered electro-optic device according to any one of clause 1 to clause 12, wherein the chemically-resistant multi-layered electro-optic device comprises a piezoelectric layer comprising a piezoelectric material, the piezoelectric layer being disposed between the first light-transmissive electrode layer and the electro-optic material layer or between the second electrode layer and the electro-optic material layer.

Clause 14: A method for manufacture of a chemically-resistant multi-layered electro-optic device, the chemically resistant multi-layered electro-optic device comprising, in order, a first substrate layer, a first light-transmissive electrode layer, an electro-optic material layer, a second electrode layer, a first adhesive layer, and a second substrate layer, the method for manufacture of a multi-layered electro-optic device comprising the steps: (1) providing an electro-optic sheet, the electro-optic sheet comprising, in order, the first substrate layer, the first light transmissive electrode layer, the electro-optic material layer, and the second electrode layer, the second electrode layer comprising a conductive polymer; (2) forming a wet film on the second electrode layer by application of an aqueous adhesive composition onto the second electrode layer of the electro-optic sheet, the aqueous adhesive composition comprising (i) from 20 to 80 weight percent of a poly(vinyl alcohol) by weight of the aqueous adhesive composition excluding solvents, the poly(vinyl alcohol) containing acetoacetyl functional groups in its molecular structure, (ii) from 20 to 80 weight percent of a polyurethane, a self-crosslinking acrylic polymer, or a mixture of polyurethane and a self-crosslinking acrylic polymer by weight of the aqueous adhesive composition excluding solvents, and (iii) an aqueous carrier; (3) curing the wet film by application of heat to form an intermediate electro-optic laminate, the intermediate electro-optic laminate comprising, in order, the first substrate layer, the first light-transmissive electrode layer, the electro-optic material layer, the second electrode layer, and an adhesive film, the adhesive film comprising from 20 to 80 weight percent of the polyurethane, the crosslinked acrylic polymer, or the mixture of the polyurethane or the crosslinked acrylic polymer by weight of the adhesive film excluding solvents, and from 20 to 80 weight percent of a poly(vinyl alcohol) by weight of the adhesive film excluding solvents, the poly(vinyl alcohol) comprising acetoacetyl functional groups, the adhesive film of the intermediate electro-optic laminate being non tacky at room temperature; (4) providing a thermoplastic film having a surface, the thermoplastic film comprising a thermoplastic resin selected from a group consisting of polyethylene, polypropylene, polybutylene, polyethylene terephthalate, an ethylene copolymer, a propylene copolymer, a butylene copolymer, and mixtures thereof, the thermoplastic film having a surface treatment, such that the surface of the thermoplastic film comprises polar functional groups; (5) pressuring together the thermoplastic film and the intermediate electro-optic laminate at a temperature of from 60° C. to 100° C., forming the chemically-resistant multi-layered electro-optic device, the first adhesive layer of the chemically-resistant multi-layered electro-optic device being disposed between the second substrate layer and the second electrode layer, the second substrate layer comprising the thermoplastic film, wherein at least a portion of the polar groups of the surface of the thermoplastic film react with acetoacetyl functional groups of the poly(vinyl alcohol) of the adhesive film such that the surface of the thermoplastic film of the second substrate layer is covalently bonded to the poly(vinyl alcohol) of the first adhesive layer.

Clause 15: The method for manufacture of a chemically-resistant multi-layered electro-optic device of clause 14, wherein the aqueous adhesive composition comprises from 0.5 to 8 weight percent of a crosslinking agent by weight of the aqueous adhesive composition excluding solvents, and wherein the adhesive film of the intermediate electro-optic laminate, which is formed in the curing step, comprises from 20 to 80 weight percent of a crosslinked poly(vinyl alcohol) by weight of the adhesive film excluding solvents, the crosslinked poly(vinyl alcohol) of the adhesive film comprising crosslinked acetoacetyl functional groups and non-crosslinked acetoacetyl functional groups.

Clause 16: The method for manufacture of a chemically-resistant multi-layered electro-optic device according to clause 14 or clause 15, wherein the aqueous adhesive composition comprises a self-crosslinking acrylic polymer or a mixture of polyurethane and a self-crosslinking acrylic polymer, the self-crosslinking acrylic polymer comprising an epoxy functional group.

Clause 17: The method for manufacture of a chemically-resistant multi-layered electro-optic device according to any one of clause 14 to clause 16, wherein the electro-optic material layer comprises an electrophoretic medium, the electrophoretic medium comprising electrically charged pigment particles, a charge control agent, and a non-polar liquid, the electrophoretic medium being encapsulated in a plurality of microcells or in a plurality of microcapsules.

Clause 18: The method for manufacture of a chemically-resistant multi-layered electro-optic device of clause 17, wherein each microcell of the plurality of microcells comprises a microcell bottom, microcell walls, a microcell opening, and a sealing layer, the sealing layer spanning the microcell opening, the sealing layer being in contact with the second electrode layer.

Clause 19: The method for manufacture of a chemically-resistant multi-layered electro-optic device according to any one of clause 14 to clause 18, wherein the conductive polymer is selected from the group consisting of poly(3,4-ethylenedioxythiophene) polystyrene sulfonate (PEDOT-PSS), polyacetylene, polyphenylene sulfide, polyphenylene vinylene and combinations thereof.

Clause 20: The method for manufacture of a chemically-resistant multi-layered electro-optic device according to any one of clause 14 to clause 19, the method for manufacture comprises a step of forming a web of the intermediate electro-optic laminate, after the formation of the intermediate electro-optic laminate.

What is claimed is:

1. A chemically-resistant multi-layered electro-optic device comprising, in order, a first substrate layer, a first light-transmissive electrode layer, an electro-optic material layer, a second electrode layer, a first adhesive layer, and a second substrate layer,
the first adhesive layer comprising
from 20 to 80 weight percent of a polyurethane, a crosslinked acrylic polymer, or a mixture of a polyurethane and a crosslinked acrylic polymer by weight of the first adhesive layer excluding solvents,
from 20 to 80 weight percent of a poly(vinyl alcohol) by weight of the first adhesive layer excluding solvents, the poly(vinyl alcohol) containing acetoacetyl functional groups in its molecular structure;
the second substrate layer being formed using a thermoplastic film having a surface, the thermoplastic film comprising a thermoplastic resin, the thermoplastic film having a surface treatment such that the surface of the thermoplastic film comprises polar functional groups, wherein at least a portion of the polar functional groups are covalently bonded to the poly(vinyl alcohol) of the first adhesive layer, the covalent bonds being formed from a reaction between the acetoacetyl functional groups of the poly(vinyl alcohol) and the polar functional groups of the surface of the thermoplastic film.

2. The chemically-resistant multi-layered electro-optic device of claim 1, wherein the electro-optic material layer comprises an electrophoretic medium, the electrophoretic medium comprising electrically charged pigment particles, a charge control agent, and a non-polar liquid, the electrophoretic medium being encapsulated in a plurality of microcells or in a plurality of microcapsules.

3. The chemically-resistant multi-layered electro-optic device of claim 2, wherein each microcell of the plurality of microcells comprises a microcell bottom, microcell walls, a microcell opening, and a sealing layer, the sealing layer spanning the microcell opening, the sealing layer being in contact with the second electrode layer.

4. The chemically-resistant multi-layered electro-optic device of claim 1, wherein the second electrode layer comprises a conductive polymer.

5. The chemically-resistant multi-layered electro-optic device of claim 4, wherein the conductive polymer is selected from the group consisting of poly(3,4-ethylenedioxythiophene) polystyrene sulfonate (PEDOT-PSS), polyacetylene, polyphenylene sulfide, polyphenylene vinylene and combinations thereof.

6. The chemically-resistant multi-layered electro-optic device of claim 1, wherein the thermoplastic film that is used to form the second substrate layer comprises a thermoplastic resin selected from a group consisting of polyethylene, polypropylene, polybutylene, polyethylene terephthalate, an ethylene copolymer, a propylene copolymer, a butylene copolymer, and mixtures thereof.

7. The chemically-resistant multi-layered electro-optic device of claim 1, wherein the first adhesive layer comprises a polyurethane or a mixture of a polyurethane and a crosslinked acrylic polymer, and wherein the polyurethane has a glass transition temperature lower than −30° C.

8. The chemically-resistant multi-layered electro-optic device of claim 1, wherein the first adhesive layer comprises a polyurethane or a mixture of a polyurethane and a crosslinked acrylic polymer, and wherein the polyurethane is crosslinked.

9. The chemically-resistant multi-layered electro-optic device of claim 1, wherein the poly(vinyl alcohol) is crosslinked, the crosslinked poly(vinyl alcohol) being formed by a reaction between the poly(vinyl alcohol) and a crosslinking agent.

10. The chemically-resistant multi-layered electro-optic device of claim 9, wherein the crosslinking agent is selected from the group consisting of dialdehyde, diamine, and organic zirconate.

11. The chemically-resistant multi-layered electro-optic device of claim 1, wherein the poly(vinyl alcohol) has a degree of hydrolysis of from 90 to 99 percent.

12. The chemically-resistant multi-layered electro-optic device of claim 1, wherein the first adhesive layer comprises a crosslinked acrylic polymer or a mixture of a polyurethane and a crosslinked acrylic polymer, the crosslinked acrylic polymer being formed by crosslinking of a self-crosslinking acrylic polymer comprising an epoxy functional group.

13. The chemically-resistant multi-layered electro-optic device of claim 1, wherein the chemically-resistant multi-layered electro-optic device comprises a piezoelectric layer comprising a piezoelectric material, the piezoelectric layer being disposed between the first light-transmissive electrode layer and the electro-optic material layer or between the second electrode layer and the electro-optic material layer.

14. A method for manufacture of a chemically-resistant multi-layered electro-optic device, the chemically resistant multi-layered electro-optic device comprising, in order, a first substrate layer, a first light-transmissive electrode layer, an electro-optic material layer, a second electrode layer, a first adhesive layer, and a second substrate layer, the method for manufacture of a multi-layered electro-optic device comprising the steps:
providing an electro-optic sheet, the electro-optic sheet comprising, in order, the first substrate layer, the first light transmissive electrode layer, the electro-optic material layer, and the second electrode layer, the second electrode layer comprising a conductive polymer;
forming a wet film on the second electrode layer by application of an aqueous adhesive composition onto the second electrode layer of the electro-optic sheet, the aqueous adhesive composition comprising (i) from 20 to 80 weight percent of a poly(vinyl alcohol) by weight of the aqueous adhesive composition excluding solvents, the poly(vinyl alcohol) containing acetoacetyl functional groups in its molecular structure, (ii) from 20 to 80 weight percent of a polyurethane, a self-crosslinking acrylic polymer, or a mixture of polyurethane and a self-crosslinking acrylic polymer by weight of the aqueous adhesive composition excluding solvents, and (iii) an aqueous carrier;
curing the wet film by application of heat to form an intermediate electro-optic laminate, the intermediate electro-optic laminate comprising, in order, the first substrate layer, the first light-transmissive electrode layer, the electro-optic material layer, the second electrode layer, and an adhesive film, the adhesive film comprising from 20 to 80 weight percent of the polyurethane, the crosslinked acrylic polymer, or the mixture of the polyurethane or the crosslinked acrylic polymer by weight of the adhesive film excluding solvents, and from 20 to 80 weight percent of a poly(vinyl alcohol) by weight of the adhesive film excluding solvents, the poly(vinyl alcohol) comprising acetoacetyl functional groups, the adhesive film of the intermediate electro-optic laminate being non tacky at room temperature;
providing a thermoplastic film having a surface, the thermoplastic film comprising a thermoplastic resin selected from a group consisting of polyethylene, polypropylene, polybutylene, polyethylene terephthalate, an ethylene copolymer, a propylene copolymer, a butylene copolymer, and mixtures thereof, the thermoplastic film having a surface treatment, such that the surface of the thermoplastic film comprises polar functional groups;
pressuring together the thermoplastic film and the intermediate electro-optic laminate at a temperature of from 60° C. to 100° C., forming the chemically-resistant multi-layered electro-optic device, the first adhesive layer of the chemically-resistant multi-layered electro-optic device being disposed between the second substrate layer and the second electrode layer, the second substrate layer comprising the thermoplastic film, wherein at least a portion of the polar groups of the surface of the thermoplastic film react with acetoacetyl functional groups of the poly(vinyl alcohol) of the adhesive film such that the surface of the thermoplastic film of the second substrate layer is covalently bonded to the poly(vinyl alcohol) of the first adhesive layer.

15. The method for manufacture of a chemically-resistant multi-layered electro-optic device of claim 14, wherein the aqueous adhesive composition comprises from 0.5 to 8 weight percent of a crosslinking agent by weight of the aqueous adhesive composition excluding solvents, and wherein the adhesive film of the intermediate electro-optic laminate, which is formed in the curing step, comprises from 20 to 80 weight percent of a crosslinked poly(vinyl alcohol) by weight of the adhesive film excluding solvents, the crosslinked poly(vinyl alcohol) of the adhesive film comprising crosslinked acetoacetyl functional groups and non-crosslinked acetoacetyl functional groups.

16. The method for manufacture of a chemically-resistant multi-layered electro-optic device of claim 14, wherein the aqueous adhesive composition comprises a self-crosslinking acrylic polymer or a mixture of polyurethane and a self-crosslinking acrylic polymer, the self-crosslinking acrylic polymer comprising an epoxy functional group.

17. The method for manufacture of a chemically-resistant multi-layered electro-optic device of claim 14, wherein the electro-optic material layer comprises an electrophoretic medium, the electrophoretic medium comprising electrically charged pigment particles, a charge control agent, and a non-polar liquid, the electrophoretic medium being encapsulated in a plurality of microcells or in a plurality of microcapsules.

18. The method for manufacture of a chemically-resistant multi-layered electro-optic device of claim 17, wherein each microcell of the plurality of microcells comprises a microcell bottom, microcell walls, a microcell opening, and a sealing layer, the sealing layer spanning the microcell opening, the sealing layer being in contact with the second electrode layer.

19. The method for manufacture of a chemically-resistant multi-layered electro-optic device of claim 14, wherein the conductive polymer is selected from the group consisting of poly(3,4-ethylenedioxythiophene) polystyrene sulfonate (PEDOT-PSS), polyacetylene, polyphenylene sulfide, polyphenylene vinylene and combinations thereof.

20. The method for manufacture of a chemically-resistant multi-layered electro-optic device of claim 14, the method for manufacture comprises a step of forming a web of the intermediate electro-optic laminate, after the formation of the intermediate electro-optic laminate.
